(19) United States
(12) Patent Application Publication
(10) Pub. No.: US 2024/0134041 A1
(43) Pub. Date: Apr. 25, 2024

(54) OBJECT IMAGING WITHIN STRUCTURES

(71) Applicant: SONAIR AS, Oslo (NO)

(72) Inventors: Tobias DAHL, Trondheim (NO); Frode TYHOLDT, Trondheim (NO); Jon TSCHUDI, Trondheim (NO)

(73) Assignee: Sonair AS, Oslo (NO)

(21) Appl. No.: 18/274,191

(22) PCT Filed: Feb. 1, 2022
(86) PCT No.: PCT/GB2022/050264

§ 371 Date: Jul. 25, 2023

(30) Foreign Application Priority Data
Feb. 1, 2021 (GB) 2101374.3

(51) Int. Cl. G01S 15/89; G01S 7/521; H04R 1/40; H04R 3/00; H04R 19/04

(52) U.S. Cl. CPC G01S 15/89; G01S 7/521; H04R 1/406; H04R 3/005; H04R 19/04; H04R 2201/003; H04R 2201/401

(57) ABSTRACT

A method and system of imaging at least one passive object within a surrounding structure is provided. The surrounding structure has multiple surfaces. The method includes: transmitting an ultrasonic signal into the surrounding structure using an array of ultrasonic transmitters and receiving reflections from the passive object using an array of ultrasonic receivers. The method also includes steering the ultrasonic signal such that it includes at least one reflection off a surrounding structure surface using stored data relating to a position of at least one of the surfaces.

This invention relates to imaging of objects within a surrounding structure—particularly, although not exclusively, a structure having walls such as a room or other enclosure.

There are many different applications where it is useful to be able to determine what is in a room or other enclosed space. One way of doing this is of course to use a camera. However, traditional optical imaging introduces line-of-sight problems as parts of the space may be obscured by objects or structural features. Multiple cameras may therefore be required in order to fully image a room.

For example, when determining the occupancy level of a room such as for building control or fire safety purposes, cameras are only able to provide a 2D image of the room. If the room has a high occupancy level, some people may block the camera from imaging others, and thus prevent obtaining an accurate measurement of the occupancy level, as only people in the line of sight may be imaged. In order to provide an image of the people which are hidden from the line of sight of the camera, multiple other cameras must therefore be used to provide multiple viewpoints of the room.

Cameras are also not ideal for imaging applications such as imaging the interior of an enclosed container as there could be a lack of visible light for imaging.

The Applicant has therefore appreciated that there are shortcomings associated with traditional optical imaging in such circumstances.

When viewed from a first aspect the present invention provides a method of imaging at least one passive object within a surrounding structure having a plurality of surfaces, the method comprising:
transmitting an ultrasonic signal into the surrounding structure using an array of ultrasonic transmitters;
receiving reflections from the passive object using an array of ultrasonic receivers;
steering the ultrasonic signal such that it includes at least one reflection off a surrounding structure surface using stored data relating to a position of at least one of said surfaces.

The invention extends to a system arranged to carry out the imaging method described above.

Thus it will be seen by those skilled in the art that in accordance with the invention, both direct and indirect (reflected from the structure) ultrasonic signals are used to image the passive object when combined with knowledge of the surrounding structure. In accordance with the invention an image of the passive object can be determined using the reflections. This addresses one of the shortcomings of the optical camera imaging approach identified by the Applicant in that using indirect reflections from the surrounding structure surfaces to image the object enables a single array of transmitters/receivers to effectively image from multiple viewpoints. For example, if the surrounding structure is a room, the ultrasonic signal can reflect off walls, floor and the ceiling. The walls, floor and ceiling may therefore act as ‘secondary virtual sources’ and provide multiple effective viewpoints from which the object can be imaged using the single array.

Typically the array of ultrasonic transmitters and array of ultrasonic receivers will typically be in respective housings or, preferably, a common housing. It should be understood that references herein to a surrounding structure are not intended to refer to such housings but rather to a structure in which the arrays and the objects being imaged are disposed.

By way of comparison, multiple optical cameras would be required in order to image an object from multiple different viewpoints. These multiple viewpoints enable imaging of the sides of an object which are not in the direct line of sight of the array, as well as enabling imaging of occluded objects which are blocked by line-of-sight.

Imaging using ultrasound introduces other benefits compared to conventional cameras, in addition to the reflection from surrounding structure surfaces described above. Unlike light, ultrasound does not pass through windows, and is instead reflected by them—a glass window is not ‘transparent’ to ultrasonic signals. This is advantageous particularly in cases of imaging objects in a room, as the windows may also act as ‘secondary virtual sources’ of ultrasonic signals due to the reflections.

Further to this, imaging with ultrasound as opposed to light provides greater privacy, for example, if people in a room are being imaged. People may feel more comfortable with being imaged using an ultrasonic array, as opposed to having a camera directed towards them to image them because ultrasound typically cannot be used to image at a resolution where it can be used for surveillance purposes.

By having control of the transmitter and receiver array in accordance with the invention, range-gating may be used. The ultrasonic signal may therefore be analysed in post-processing based at least partially on the distance that a signal has travelled from the transmitter to the receiver, measured by the time it has taken and knowledge of the local speed of sound. For example objects nearer to the transmitter/receiver array may be analysed, and thus imaged first, and objects further away imaged subsequently through selecting signals which are received in a certain time frame, to image only objects within the corresponding range. This may allow knowledge of the location of the closest objects to improve imaging of the more distant objects—e.g. by steering the transmitted or reflected beams around the closer objects. As will be appreciated, knowledge of the surrounding structure and steering of the beam in accordance with the invention allow account to be taken of the extra propagation time of signals reflected from surfaces in the structure.

Reflections may be obtained from every object/surface in the surrounding structure. Each received, reflected signal will result from a certain transmitted signal and reflection from an object/surface in the surrounding structure. As such, every object of sufficient size in the room will map onto a unique set of impulse responses between the transmitters and receivers in the array. Therefore, a representation of every object in the surrounding structure may in theory be obtained from a single array, without the requirement for multiple sensors in multiple locations in the surrounding structure. Although it may be computationally complex to compute the locations of every object/surface in the surrounding structure from the received impulses, the information is contained within the reflected signals.

Beam steering may be used on either the transmitted ultrasonic signal, reflected ultrasonic signal, or both. In transmission this can be done by actively directing energy preferentially in a given direction, in order to steer the transmitted ultrasonic signal by adding determined phase adjustments to each transmitted signal in the array such that the resultant ultrasonic signals undergo interference, resulting in an overall transmitted signal which is directed. Alternatively suitable phase adjustments may be applied on the calculations carried out during post-processing. The received, reflected ultrasonic signal may be steered in a similar way.

In some embodiments therefore, steering of both the transmit and receive signals may effectively be conducted using only software rather than being ‘physically’ steered. This is because for static scenes, it is possible to record the impulse responses between each transmitter and each receiver, for example by using a pulse-echo measurement or by using coded signals such as chirps or pseudo-random-codes to obtain full acoustic information of the channel. It is then possible effectively to simulate the effects of transmit beamforming using the full set of channel impulse responses.

In practice however, it is often beneficial to use actual or ‘physical’ steering of the transmit beam for at least two reasons. Firstly, when objects are moving in the scene, such as people walking around in the room, the channel impulse response is not constant. Hence, analysing the impulse response alone amounts to analysing information from the past. It may be beneficial to steer the (transmit) acoustic beam towards a number of known moving objects, in order to optimize the signal to noise ratio (SNR) in the direction of those objects. The transmit beam may be steered sequentially towards any number of targets, or a combined beam highlighting more than one object at a time may be used.

Secondly, even for static scenes, the impulse response may not necessarily be completely static. This may be due to temperature and humidity changes which affect the speed of sound, or changing gradients around the room, which effectively lead to various delays of the echoes around the scene. The longer the path length to the echoic reflectors, the more prone the echo may be to repositioning. Therefore, being able to steer an acoustic transmit beam towards an object or objects of interest, implicitly reducing the additions of signals from objects not of interest may be beneficial even in the “static” situation.

In a set of embodiments signal subtraction is used, where a signal transmitted directly from the transmitter to the receiver (the direct path signal) is subtracted from a signal mix recorded prior to further processing. The signal-to-be subtracted may be computed in any convenient way: by recording it prior to objects entering the surrounding structure, or as a running average of the signals observed during a time period while objects are in motion in the scene. For pulsed transmissions or for coded transmissions followed by pulse decompression, the effects of the direct path signal may be removed or reduced by assigning a blanking period after transmission starts.

The reflections detected by the receivers in the array may be either direct and/or indirect reflections. Direct reflections are those which result from an ultrasonic signal which is transmitted towards the object in the surrounding structure, and is directly reflected back to the receivers in the array. Indirect reflections result from transmitted ultrasonic signals which are reflected both from surfaces in the surrounding structure and from the object, for example, signals which are steered towards a surface, where they are reflected to the object to be imaged, and then back to the array.

The passive object to be imaged may be either dynamic or static—e.g. the object may be able to move such as a person, or may not move such as an item of furniture. As the object is passive, it does not emit any ultrasonic signals of its own, it merely reflects those which are directed towards it.

In a set of embodiments predetermined part of a space defined by the surrounding structure is excluded from imaging. For instance, in a café, it may be useful to monitor what goes on in the room, as new customers move in and out and around, but not the staff working behind a counter whose identities may be connected to their specific locations.

There are multiple methods available to obtain the stored data relating to a position of at least one of the said surfaces, such as LI DAR scanning or optical imaging of the surrounding structure, or uploading pre-stored data—e.g. from a CAD drawing of the surrounding structure. However, in a set of embodiments, the ultrasonic transmitter/receiver array is used to estimate position(s) of the surrounding structure surface(s) prior to the beam steering, e.g. in a learning, or setup phase, as well as subsequently to image any objects in the room using beam steering and reflections from surfaces of the surrounding structure. This may reduce the complexity involved in setting up an imaging system in accordance with the invention.

Instead of carrying out a single or infrequent ‘learning phase’, the ultrasonic array(s) could be used to establish the surrounding structure more frequently. In a set of embodiments therefore, the surrounding structure surface information is updated during imaging or between episodes of imaging. This would be useful for example where the surrounding structure and array move relative to each other. For example the surrounding structure itself may be subject to a change in shape.

For example a robotic gripper which is being controlled to pick up an object will change shape as it closes around the object. The ultrasonic array may therefore regularly update the information relating to the positions of the surfaces in the surrounding structure, to improve imaging as the surrounding structure changes shape. It is difficult to carry out near-field imaging using optical or radar techniques. If an ultrasonic array is affixed to the robotic gripper, the nearfield geometry may be determined using the techniques described above in relation to determining the location of surfaces of the surrounding structure. The near-field reflections may therefore be used for imaging the object to be picked up by the gripper whilst the gripper is moving towards the object and changing its shape.

However obtained, the data relating to the surfaces of the surrounding structure may be stored locally to the array, e.g. to permit local processing. However this is not essential.

To further improve the images obtained of the object, in a set of embodiments the steering of the ultrasonic signal is an iterative procedure. For example, initially the transmitters in the transmitter array may emit an ultrasonic signal to obtain the positions of the surfaces of the surrounding structure as outlined above. Once this information is obtained, the signal may be steered towards the surfaces of the surrounding structure (in order to cause the signals to reflect therefrom) to obtain an image of the object. This may then be repeated to adjust and improve the beam steering once the location of the object, and/or basic shape of the object, is known in order to further improve the object image. This enables the object to be imaged at a finer resolution once the location of it is known, as the beams can be steered towards the surfaces and/or object to image only the object, rather than directing a portion of the ultrasonic signals into empty space. This iterative procedure may result in a more detailed and accurate image of the object. As will become clear from the mathematics below, in the situations where both the locations of the enclosure and an object within it are imaged, a test may be performed to determine whether the shape of the enclosure is correctly computed, and further adjustments to this may be made.

In a set of embodiments, the reflections which comprise a received signal are compared against an estimated received signal. The estimated received signal may be based on a simulated image from past characteristics of the surrounding structure, a past image of the object of interest in the surrounding structure, or a preliminary image of the object. The estimated received signal for the object of interest may thus be simulated for one or more reflections of the ultrasonic signal from the array. Through a comparison of the estimated received signal with the actual received signal, the accuracy of the estimated signal may be determined and thus if the match is over a chosen threshold, it follows that the correct image has been simulated. To compare the two signals, a gradient search may be performed, where an error function is obtained from the vectors of the signals, as explained in detail below.

At any point in the process of obtaining a reflective image, the modelled impulse responses may be matched or modelled with the true estimates. The formula y=Da can be used to predict the impulse responses (see the detailed description for further explanation), where the received signal is y, where a represents the reflective strength of the target at the specified grid position, and D is a matrix describing the path loss and time delays of the signals. More generally, the matrix D may contain as its column vectors the hypothesised impulse responses that would occur if there was a perfect point reflector at a given position, and the sound travelled from a specific transmitter to that point and to the receiver—and then include all the echoes that could also arise as the sound wave bounces off the surrounding structure (e.g. walls) and other objects therein.

More generally this may include a more complex formulation:

y=f(α)

where f could incorporate and deal with effects like diffraction, chaotic reverberations, absorption, reflections, and non-linear effects sub-and super-harmonics. The function f may represent a computer program or software simulation package for modelling wave propagation, such as COMSOL or DREAM or Field II. If f can be approximated locally around a by some differentiable function

f(α)≈\tilde{f}(α)

Then the parameter α can be updated by using a gradient search based on the cost function

e(α)=∥y−\tilde{f}(α)∥₂²

At each step, and for each estimate of α, an updated estimate of this parameter may therefore be computed as

αᵢ₊₁=αᵢ−t∇e(αᵢ)

Where ∇e denotes the gradient of the function e, and t is a certain step length that is tuned to give the minimum error e(α). This process may be repeated until convergence. More sophisticated techniques involving the Hessian can be employed, or non-linear approaches like Simplex searches. Also, more complex cost functions can be considered, such as

e(α)=∥g(y)−g(\tilde{f}(α))∥₂²

Where the function g( ) can be a function estimating the envelope of the impulse responses/signal estimates in question. This can be useful in coarsely mapping the space, as there is less need for an exact match between the observed and predicted impulse responses. This may in turn help identify the 0-positions from which no reflections are received. More generally, the error function can be any suitable distance function or norm:

e(α)=d(y,\tilde{f}(α))

Where d could be any suitable function such as a Haussdorf norm, or an information-theoretic function.

In a set of embodiments, a Doppler shift of the ultrasonic signal may be used. As will be appreciated, if the passive object is moving, it will impose a Doppler shift on the ultrasonic signal(s) depending on how fast and in what direction it is moving relative to the signal. Taking into account this Doppler shift, e.g. when processing the received ultrasonic signal, may help to enhance imaging performance further.

For example, this could be used to account for Doppler shift in the signal and so allow for more accurate instantaneous localisation of the object. Additionally, or alternatively, the derived movement could be used as an input for a motion tracking algorithm.

In a set of embodiments, the transmitted signal is steered based on characteristics of the object. For example, information relating to the shape, size or motion of the passive object may be obtained, and the steering of the transmitted signal may be adjusted and improved based on these characteristics to improve the imaging of the object. For example, if the object is very large, and a large proportion of it is blocked from the line of sight of the imaging array, the beam steering may be adjusted such that the beam is steered more towards the surrounding structure, in order to use indirect reflections to image the occluded parts of the object. It may be desirable to image using a single steered beam, or alternatively the array may use beamforming such that multiple beams are transmitted in different directions to improve imaging of the object. The multiple beams may be transmitted simultaneously, or alternatively the array may ‘scan’ by emitting steered beams in different directions over a short timeframe. Additionally, the ‘shape’ of the transmitted beam may be modified to match that of the expected object in order to further improve the imaging of the object by focussing the energy of the beam predominantly onto the object. By doing this an improved signal to noise ratio may be achieved.

Although the above method and system could just be used simply to establish information about objects in a surrounding structure, in a set of embodiments, a beam of audible audio is actively steered towards the object based on a determined location of the object. This audio beam will thus be of a different frequency to that of the ultrasound signal—for example the audio beam will be at a frequency which is audible to humans. The passive object may, in this instance, be a person. Through using ultrasound to map the room which the person is in, the locations of the walls and ceiling may be obtained. The location of a person or persons in the room may also be determined using the ultrasonic array. This information may then be used to steer audio beams towards the user, utilising reflections and reverberations in the room constructively, to provide the user with an optimised audio experience.

Additionally or alternatively, through ultrasonic imaging of the room as described herein, it may be determined where users are most likely to sit, so that audio is directed towards that area to optimise its delivery, without needing to determine that there is in fact someone there.

If there are multiple users or areas in the room, the audio output beams may be steered towards each of those users or areas, such that each receives an enhanced audio experience, at the cost possibly of sacrificing an optimal experience for one user or area only.

Additionally or alternatively, through determining the location of users in the room using ultrasonic imaging, audio which originates from the users, such as speech, may be steered when received by microphones. This is useful for example, in video conferencing, where there may be multiple people in a room, to steer the sound from the person who is talking towards the microphone to ensure those who are connected by video receive high quality audio from the speaker.

In a set of embodiments, a visual representation of the object is created. This visual representation may comprise a computer generated image of the object(s) or may provide a more abstract indication of the extent or size of an object within the surrounding structure.

In one specific use case for example, the surrounding structure is the internal cavity of a refuse collection truck. The ultrasonic array may therefore be used to work out which part of the cavity is occupied and to what extent. Reflections from the ceiling and walls may be input to an external processor, which determines the remaining capacity of the cavity. The visual representation may therefore show how full the cavity is, and how much empty space is remaining. This may then be displayed on an external screen, for example to a driver of the refuse collection truck, to enable them to know when the truck is full and will require emptying.

The transmitters and receivers in the array could be combined such that the array comprises multiple composite transceivers, or a separate array of transmitters and separate array of receivers may be provided. In a set of embodiments however, a single array comprising separate transmitters and receivers therein is provided. This may be advantageous over having separate arrays in terms of reducing size and saving material costs.

Having separate transmitters and receivers—either in respective arrays or as separate elements in a single array—may be advantageous as no switching electronics are required to switch between an element acting as both a receiver and a transmitter, and in the latter case a dedicated transmitter and dedicated receiver may be integrated onto a single semiconductor die to allow for simultaneous transmission and receiving of signals.

Additionally, separating the transmitters and receivers means that a ‘blanking period’ can often be avoided at the receiver, i.e. the time-window during which the receiver is ‘shut down’ because it acts as a transmitter at the time. This in turn means that with traditional switching systems using transceivers, it is difficult to measure distances to objects which are very close to the sensor/transmitter setup. When a longer, lower-power transmission is used, the receiver can ‘listen’ while transmission is on-going, and pick up superpositions of echoes and direct-path sound between transmitter and receivers. This can in turn enable imaging of nearby objects such as in the robot gripper example above.

Advantageously, in a set of embodiments, the separate transmitters and receivers are fabricated using different piezoelectric materials. For example, the ultrasonic transmitter may be fabricated using PZT, and the ultrasonic receiver may be fabricated using AlN. PZT typically outputs higher sound pressure at lower voltages than AlN. PZT can also be used to output more broadband signals than AlN because of its ability to provide higher sound pressure levels. This can effectively be done by providing more output power away from one or more resonance peaks, and less power at or close to resonance peaks, so that a relatively flat, broadband signal is in effect output from the transmitter. Although this is also possible using AlN, the typical resulting output energy at non-resonant frequencies is typically much lower, and it therefore becomes less practical to use the transmitter in this ‘broadband manner’ when fabricated using AlN. Bandwidth is critical in many imaging applications, because it directly provides better depth resolution, and indirectly also provides better angular resolution. This is because the side-lobes and grating lobes of different frequencies have different spatial locations and hence some frequencies are better for resolving closely overlapping objects in some sectors than others. Also, a broader spectrum of frequencies generally have better angular separation capabilities than one or a few individual frequencies alone. In another set of embodiments both the transmitters and receivers are fabricated from Aluminium-Scandium-Nitride or other suitable piezoelectrics.

Once the transmitted signals have been generated so as to provide a sufficiently strong echo received from the surroundings, it is desirable to receive the echoes with as high a signal-to-noise ratio (SNR) as possible. This is important both for detection of objects (threshold sensitivity), and for array methods for object separation, where resolution typically is a function of SNR, as well as sensor placement and spacing among other factors. For example, super-resolution imaging methods generally rely on high SNR, see e.g. Christensen-Jeffries, K. et al., “Super-resolution ultrasound imaging”, Ultrasound in Medicine & Biology, 2020, 46(4), 865-891. AlN has a higher receive sensitivity than PZT, and as such is better suited to this purpose. A better SNR leads to better ultrasound detection, and better effective beamforming in array beamforming applications. In addition to this, a sufficiently sensitive ultrasonic receiver with a good SNR drives down the need for excessive output power (i.e. there is less need for a strong signal to improve the SNR) and use excessive power in the device.

For instance, in room imaging applications, a device using multiple piezoelectric micro-machine ultrasonic transducers (PMUTs), each of which comprises a separate transmitter and receiver, in the array may be battery powered, and unnecessarily high power output levels would reduce the battery life. The array may therefore operate at low power due to the high SNR achieved using the different materials for the receivers and transmitters.

In a set of embodiments, the ultrasonic signal has a high fractional bandwidth. For example, the fractional bandwidth may be 20%, so for a 100 kHz central frequency, there will be a bandwidth of 20 kHz. A high bandwidth may help to disambiguate multiple peaks in the reflected received signals. Additionally, if the transmitters in the array are fabricated using PZT, the PZT can be driven such that a reasonable sound pressure level (SPL) may be obtained even at non-resonant frequencies. This is difficult to achieve if the transmitters in the array are fabricated using AlN.

In a set of embodiments, the stored data relating to a position of at least one of the said surfaces, and the received reflection data are processed externally from the array. This allows for data sharing as the sensing occurs remotely from the computation. For example, the data may be sent to a hub for external processing, for example using Bluetooth. Analysing multiple reflections is computationally costly, and this allows for a higher power external processor to be used to analyse the data, allowing the sensor array to require minimal power and processing power. This is particularly important for wall- or sensor-mounted systems, or in movable/portable systems.

In a set of embodiments, the receiver array comprises MEMS (Micro-Electro-Mechanical System) microphones. The MEMS microphone comprises a MEMS diaphragm which forms a capacitor, with sound pressure waves causing movement of the diaphragm. MEMS microphones are able to capture both ultrasonic signals and audio signals, so may also be used for audio purposes. For example, the MEMS microphones may be used to calibrate the transmitted audio signals, to calibrate the transmitter elements, or to ‘verify’ the ultrasound surrounding structure shape hypothesis. The MEMS microphone array can also be used, jointly with other microphones or microphone arrays in the room, to obtain better estimates of audio from a specific source of interest, by using beam-steering techniques.

In a set of embodiments, the receiver array is a microphone array having a peak response in the audible frequency range (20 Hz to 20 kHz); and the transmitter array has a spacing between the transmitters equivalent to a half-wavelength of a sound wave in the ultrasonic frequency range (above 20 kHz).

Spacing the transmitters apart by a distance equivalent to a half-wavelength of a sound wave in the ultrasonic frequency range is helpful for beamforming and helps to remove the problem of grating lobes. The spacing can be understood as the centre-centre spacing of the closest elements of the array (i.e. the transmitters). For example, taking the speed of sound to be 343 m/s, the spacing between transmitters may be less than 8 mm (i.e. approximately a half-wavelength in the ultrasonic range, λ_{ultrasound}/2).

The microphone array has a peak response in the audible frequency range, which means the microphone array is effectively optimised for receiving audio signals. More specifically the microphone array may have a peak response in a typical frequency range of speech (between 50 Hz and 500 Hz).

The advantage of this arrangement which has been appreciated by the Applicant is that the acoustic imaging functionality set out herein can be provided relatively easily in a device comprising a pre-existing microphone array—e.g. a voice assistant—by retro-fitting the transmitter array or through minimal redesign to incorporate the microphone array. Typically, the microphone array provided in such devices, although not optimised for receiving ultrasound, can also be used to receive ultrasonic signals effectively. The transmitter array, e.g. a PMUT array, advantageously has a small mutual spacing between transmitters (e.g. less than 2 mm) which is equivalent to a half-wavelength of a sound wave in the ultrasonic frequency range. This advantageously provides a compact device that is easy to embed and retrofit in a range of pre-existing devices that may themselves be compact.

For example, there are voice-controlled smart speakers (e.g. for use in smart home systems) that already include microphone arrays. As these microphone arrays may also be able to capture ultrasonic signals, and as they are provided as a pre-existing component in a device, a receiver array does not need to be retrofitted in addition to the transmitter array to implement the invention.

This allows devices making use of the invention to save on space and material costs. The effect is compounded by the relatively small spacing of the ultrasonic transmitter array, making the retrofitted transmitter component small enough to fit within most devices. In fact, this is novel and inventive in its own right. Therefore, from a further aspect the invention provides a device for imaging at least one passive object, the device comprising:
an array of ultrasonic transmitters, arranged to transmit an ultrasonic signal, wherein a pair of adjacent transmitters of said array has a spacing equivalent to a half-wavelength of a sound wave in the ultrasonic frequency range;
an array of microphones arranged to receive reflections from the passive object, wherein the microphones have a peak response in the audible frequency range;
wherein the device is arranged to determine an image of said object using said reflections.

Alternatively, the ultrasonic receiver array may comprise optical receivers. When the ultrasonic transmitter and ultrasonic receiver are made from different materials, optical receivers may be used in combination with another type of transmitter. Two suitable exemplary types of optical receivers are those which use optical multiphase readout, and optical resonators. Optical multiphase readout is described for example in WO 2014/202753, and optical resonators are described for example in Shnaiderman, R. et al., “A submicrometre silicon-on-insulator resonator for ultrasound detection”, Nature, 2020, 585, 372-378. Both these optical receiver approaches may improve the SNR of the received signals, and thus the resolution of the imaging.

In a set of embodiments, compressed sensing/sparsity methods are used to improve the resolution and accuracy in imaging the object within the surrounding structure. If there is lots of empty space in the surrounding structure, this is important information for any estimation method. In contrast with medical ultrasound, where almost every part of the human body provides some reflection, a large portion of an in-air acoustic scene may cause no reflections. In generating an image, it is therefore known that a high number of the voxels (units of graphical information defining points in 3D space) are zero. An inverse problem can then be formulated that expects many empty voxels. Alternatively, an inverse problem can be formulated that prioritises inverse problem solutions where there are many zero elements. Typically, these techniques are accurate and require a lot of more computational power than traditional beam-forming methods. The processing may therefore be carried out remotely and away from a typical battery-powered sensor platform or hub.

A particular advantage of using compressive sensing (CS) and compressive sensing-like methods over conventional beam-forming methods like Delay-and-sum and Capon beamforming, is that CS is not strictly dependent on half-wave-length sampling between the array elements. In fact, CS-like methods are known to be able to “beat Nyquist” in some important cases, see e.g.

https://www.sciencedirect.com/topics/computer-science/compressed-sensing

In the practice of using MEMS microphones as receivers for ultrasound this has an important advantage. Frequently, these elements are larger than half the wavelength for ultrasound. A typical MEMS microphone package is today of dimensions 4×3×1 mm, 1 mm being the height. At 100 kHz, an ultrasonic wavelength is 3.4 mm, and half the ultrasonic wavelength is 1.7 mm. In practice, spacing the MEMS microphone tightly, one may get wavelengths close to 3 mm, which is clearly above λ/2. The net effect of this when using traditional beam-forming approaches is so-called grating lobes, which are observable artefacts in an ultrasonic image where there may appear to be additional object at other angles than the correct one. This is a result of the fact that the wave impinging on the array looks the same at the correct angle and also at some other angles. This is similar to aliasing effects in temporal signal processing. However, CS-like methods have shown robustness to such sub-sampling problems. In the particular case of using ultrasound arrays with sub-Nyquist sampling positions, it is clear that the equation system y=Da typically has infinitely many solutions, but requiring the solution to be as sparse as possible, effectively prioritizes and choose the “simpler” solution of having an object present in one angular sector, over the alternative of having multiple objects appearing simultaneously in multiple sectors (which is a less sparse choice).

The added benefit of using CS-like methods then is that (a) use off-the shelf MEMS microphones can be used for ultrasonic imaging with good quality, and (b) also that the positioning of the MEMS microphones can be optimized for other purposes, such as obtaining the best acoustical signal or obtaining good estimates of audible sounds, e.g. by placing the microphones in an array fashion optimized for say, speech separation.

Certain embodiments of the invention will now be described, by way of example only, with reference to the accompanying drawings in which:

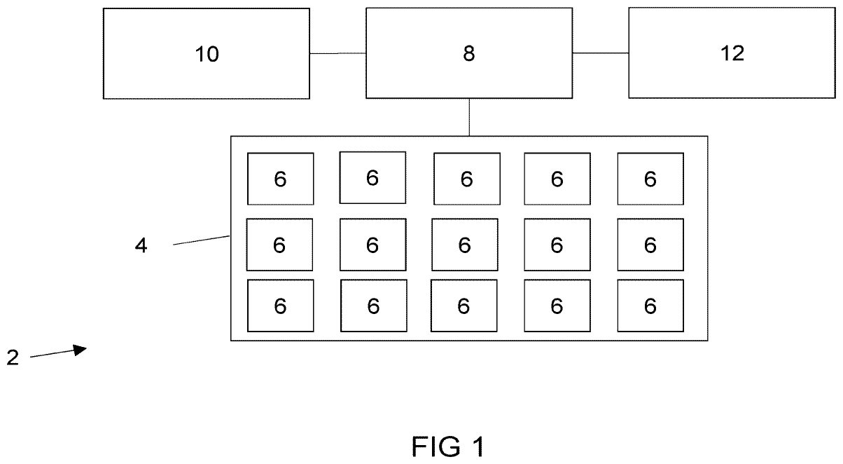

FIG. 1 is a block diagram of an ultrasound system for transmitting and receiving ultrasonic signals;

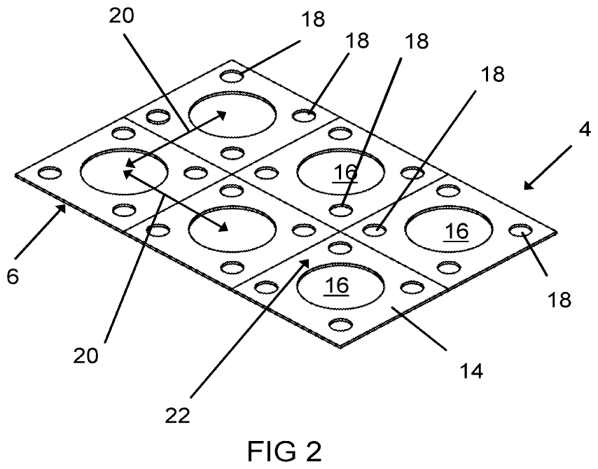

FIG. 2 is a view of a rectangular array of PM UTs for use in the system of FIG. 1;

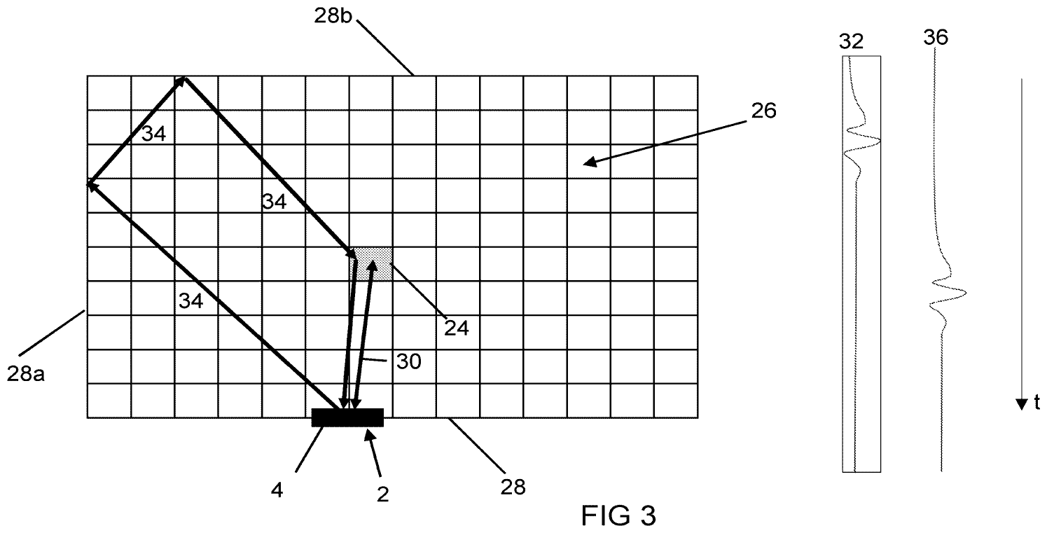

FIG. 3 is a schematic diagram of imaging an object in a room using direct reflections from the object and reflections from the walls;

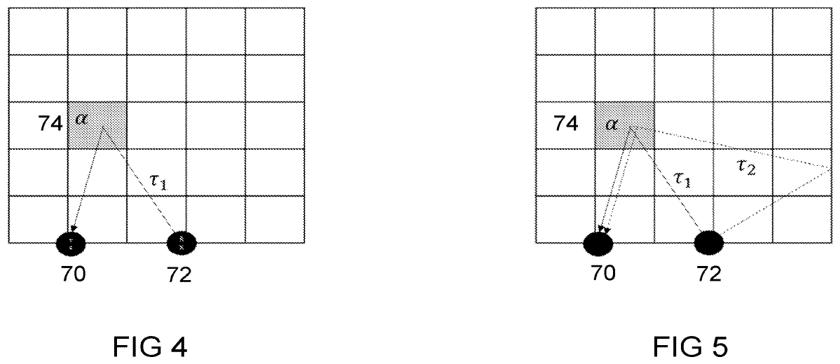

FIG. 4 is a simplified diagram of imaging a single reflector with a single transmitter and a single receiver;

FIG. 5 is a simplified diagram of imaging the reflector with the transmitter and receiver of FIG. 4 with two reflective paths;

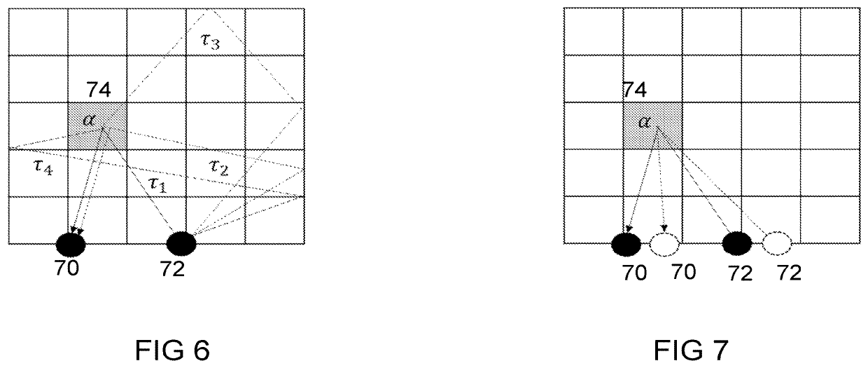

FIG. 6 is a simplified diagram of imaging the reflector with the transmitter and receiver of FIG. 4 with multiple reflective paths;

FIG. 7 is a simplified diagram of imaging a reflector with multiple transmitters and multiple receivers;

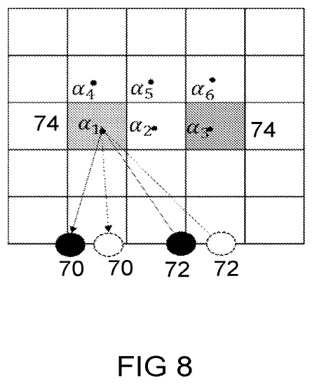

FIG. 8 is a simplified diagram of imaging multiple reflectors with multiple transmitters and multiple receivers;

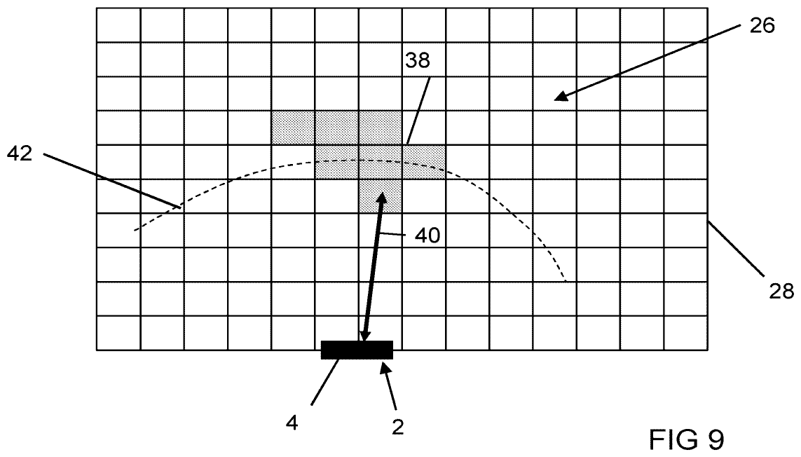

FIG. 9 is a schematic diagram of an ultrasound imaging system used for imaging a complex object in a room using beam steering to image the near field;

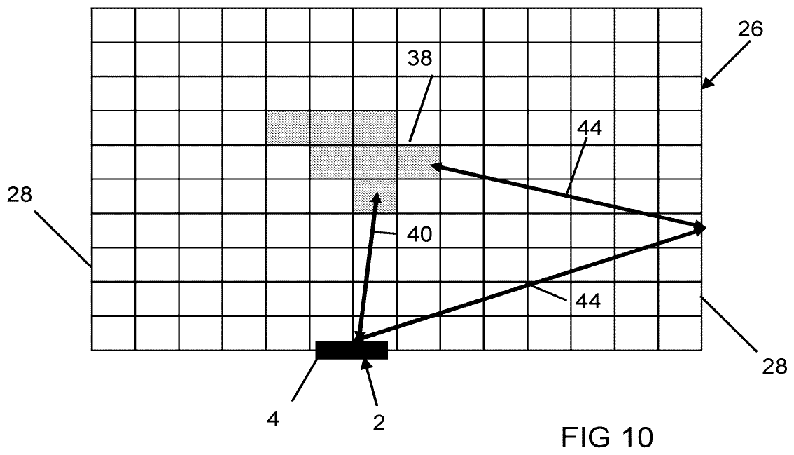

FIG. 10 is a schematic diagram of imaging a complex object in a room using indirect reflections from the walls;

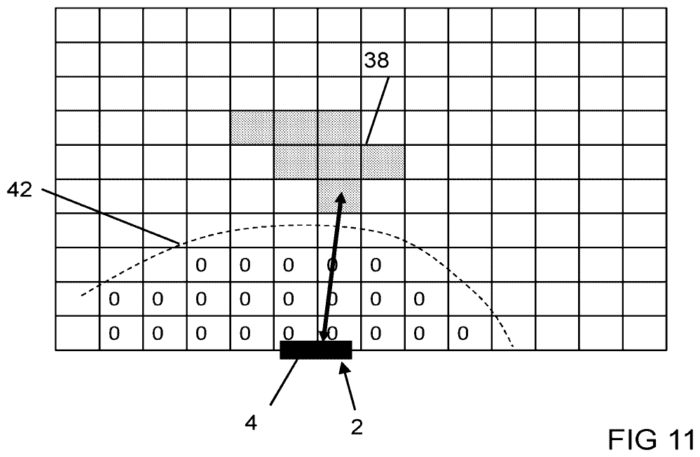

FIG. 11 is a schematic diagram of an ultrasound imaging system used for imaging a complex object in a room using beam steering to image the near field where there is lots of empty space;

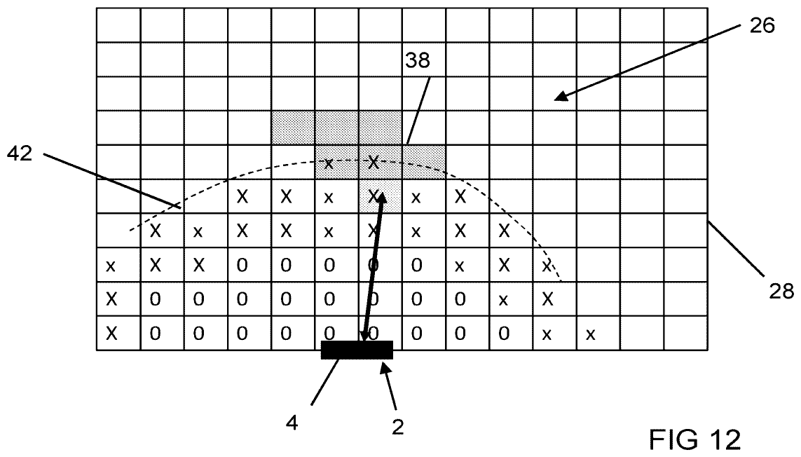

FIG. 12 is a schematic diagram of an ultrasound imaging system used for imaging a complex object in a room using beam steering to image a larger near field where there is empty space and reflections;

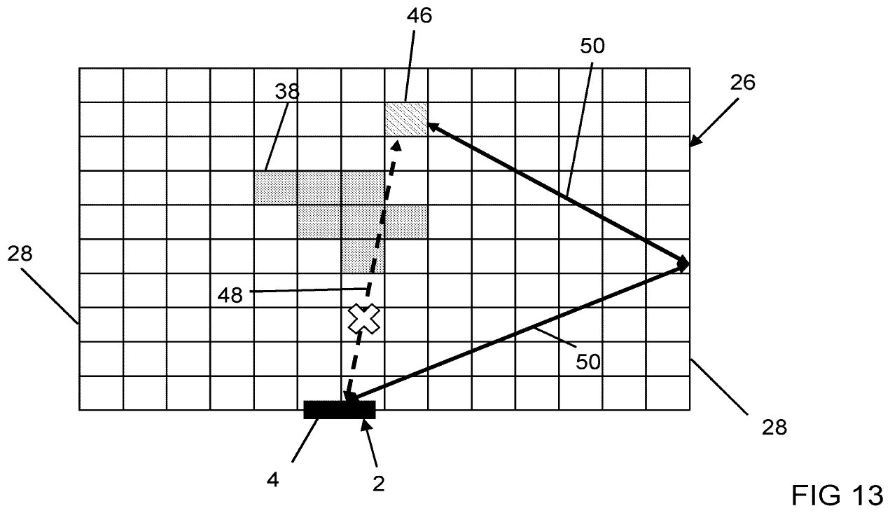

FIG. 13 is a schematic diagram of imaging an occluded object in a room;

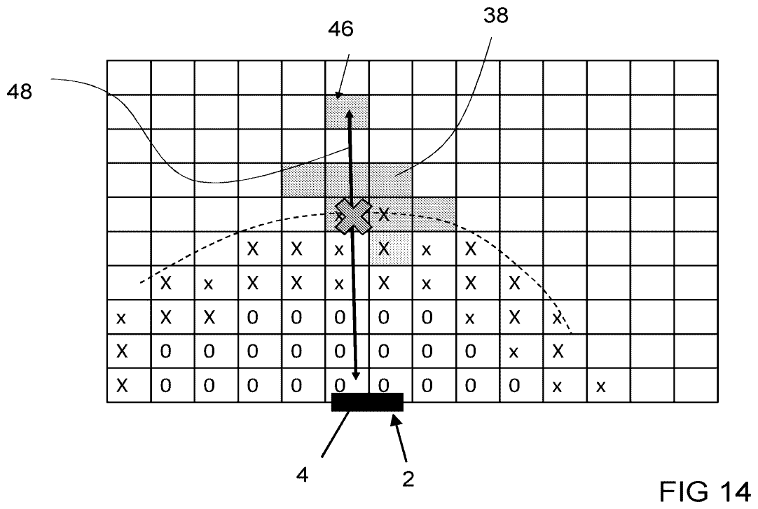

FIG. 14 is a schematic diagram of imaging an occluded object in a room where a direct path is blocked;

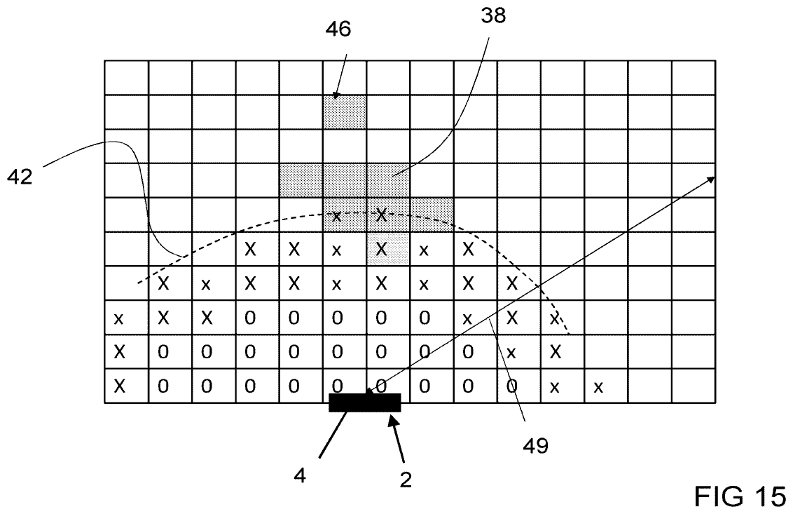

FIG. 15 is a schematic diagram of imaging an occluded object in a room using indirect reflections;

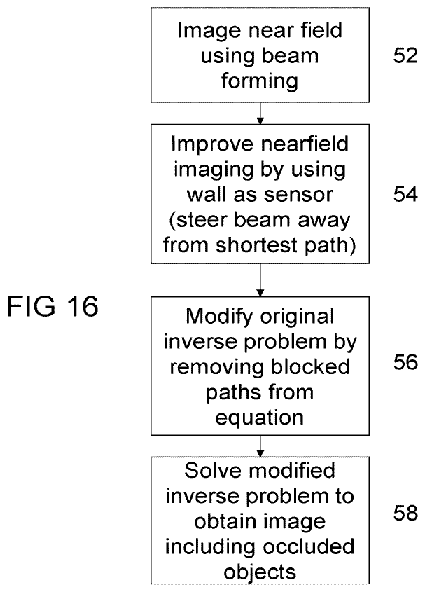

FIG. 16 is a flowchart illustrating a method of imaging an object in a room, as shown in FIGS. 4-6;

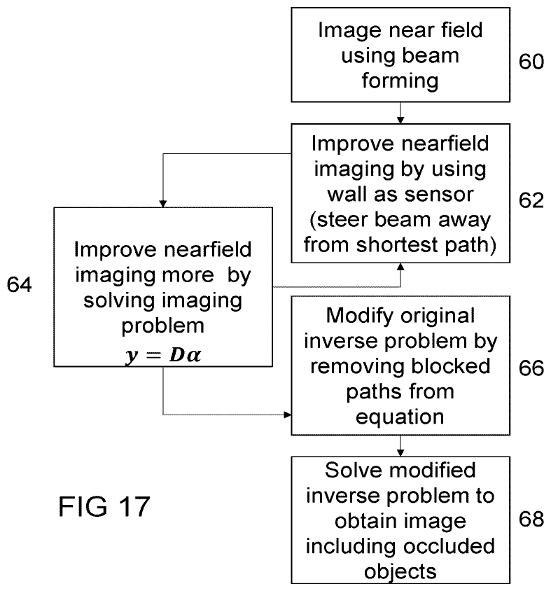

FIG. 17 is a flowchart illustrating a modified method of imaging an object in a room, as shown in FIGS. 4-6;

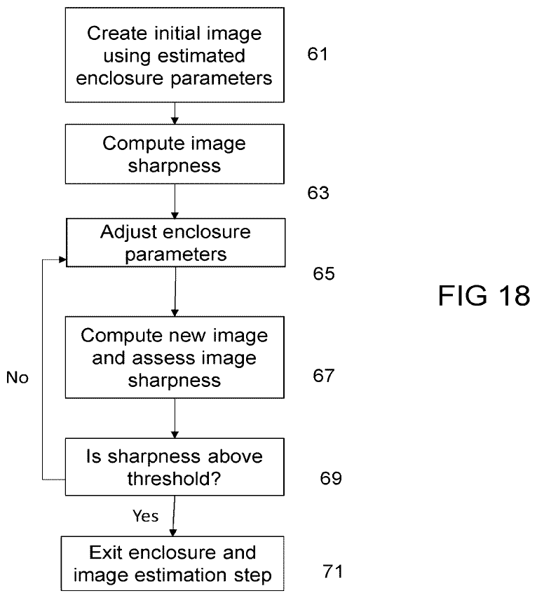

FIG. 18 is a flowchart illustrating a method of optimising the sharpness of an image;

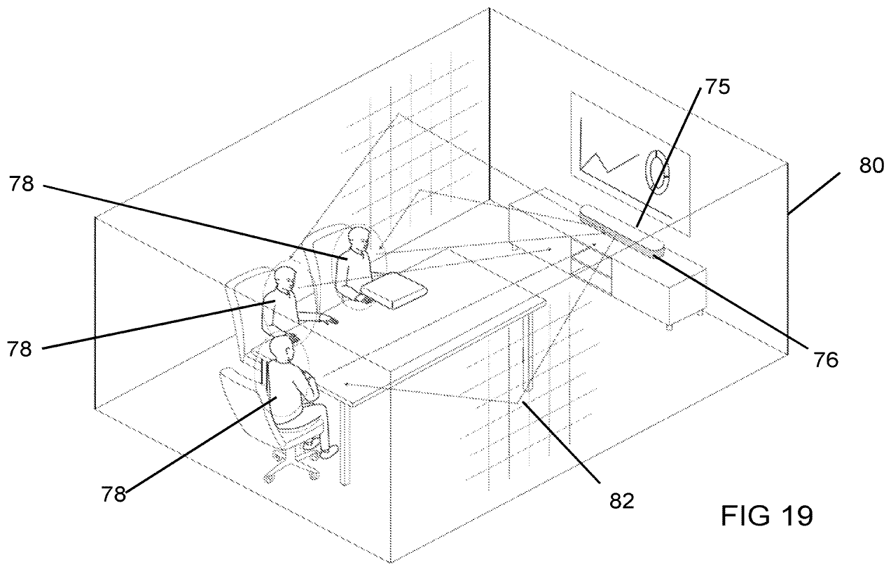

FIG. 19 shows a conference room where an array of ultrasonic transducers and microphones are used to obtain sound from a specific person in the room;

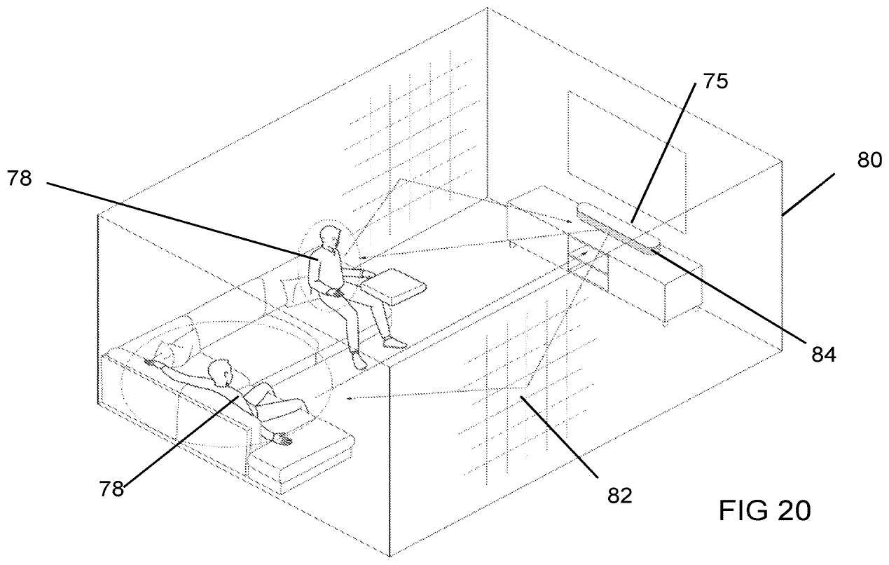

FIG. 20 shows a living room where an array of ultrasonic transducers and speakers are used to direct sound towards a specific person in the room;

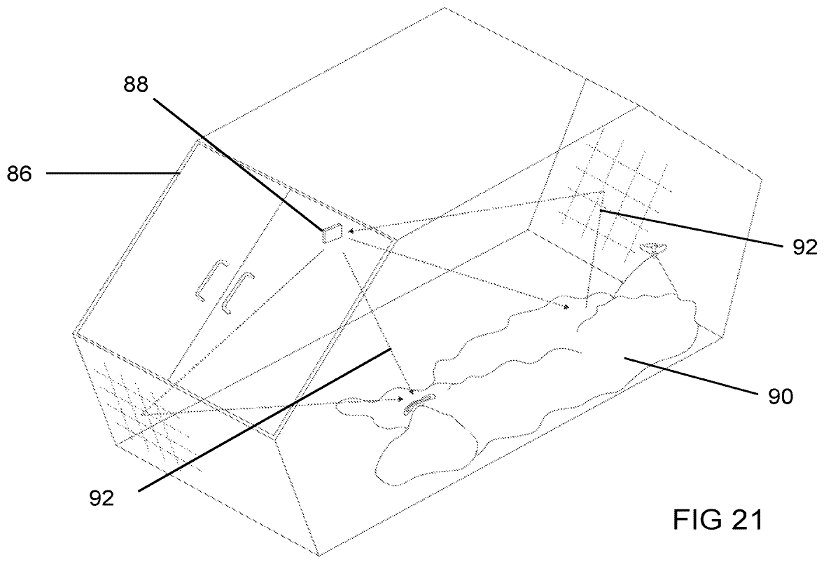

FIG. 21 shows an ultrasonic array used to image refuse in a container;

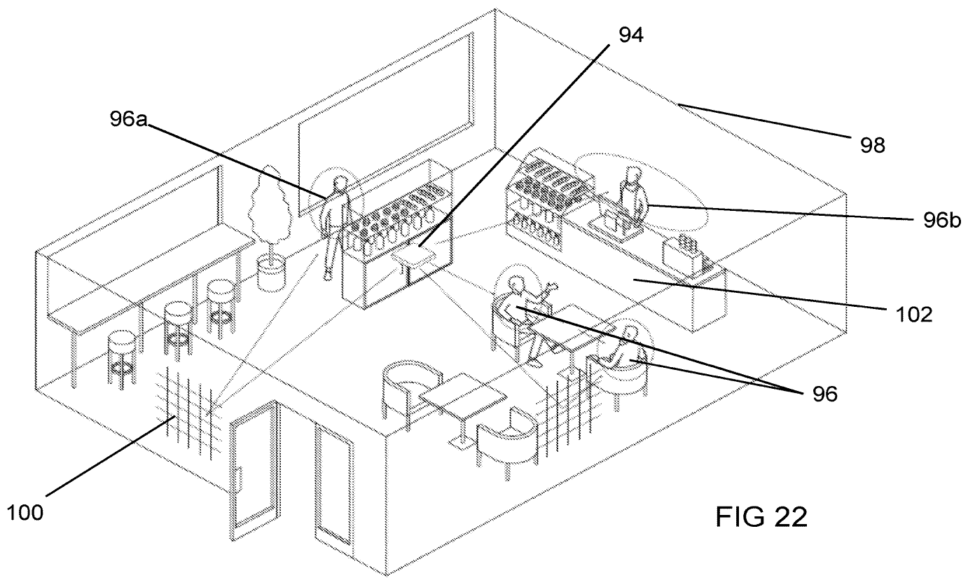

FIG. 22 shows a café where an array of ultrasonic transducers are used to determine the location of people in the café;

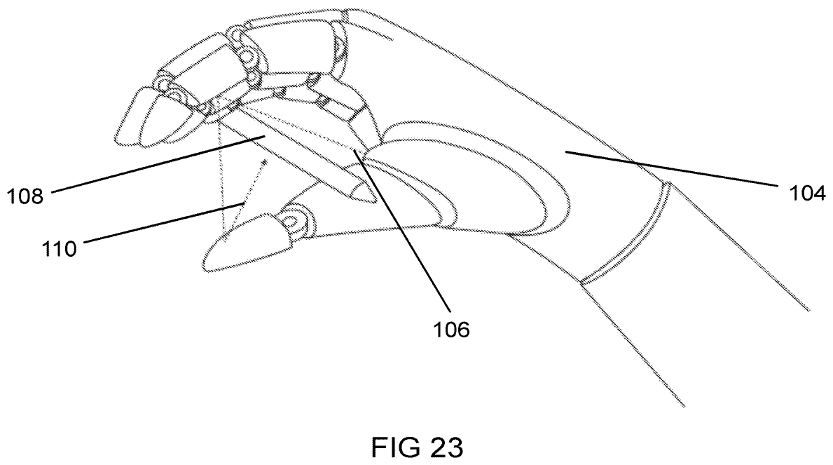

FIG. 23 shows a robot gripper arm where an ultrasonic array is used for detection of an object and the shape of the enclosure; and

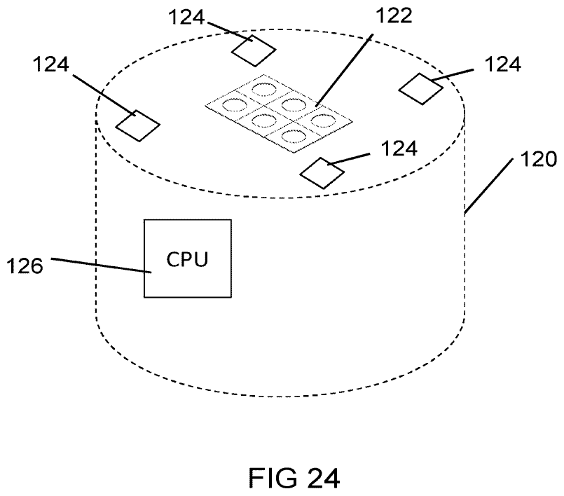

FIG. 24 shows an embodiment of the invention where an array of ultrasonic transmitters are retrofitted to a device having a built-in microphone array.

FIG. 1 shows a highly simplified schematic block diagram of the typical components of an ultrasound imaging system 2 for transmitting and receiving ultrasonic signals used for imaging a passive object in accordance with the invention described herein.

The imaging system 2 comprises an ultrasonic array 4. The ultrasonic array 4 comprises a plurality of piezoelectric micro machined ultrasonic transducers (PMUTs) 6; the array 4 is shown in further detail in FIG. 2. The system 2 includes a CPU 8 having a memory 10 and a battery 12 which will typically power all components of the system.

The imaging system 2 may, for example, be affixed to a wall of a room, and the ultrasonic array 4 configured to transmit an ultrasonic signal into the room using the PMUTs 6. As will be explained in further detail below, the ultrasonic array 4 will receive reflections from any objects in the room. The ultrasonic array 4 may then steer the ultrasonic beam to ensure the reflections include at least one reflection off a wall of the room, when the location of the walls are known.

FIG. 2 shows a rectangular array 4 of PMUTs 6. Each PMUT 6 comprises a square silicon die 14 onto which an ultrasonic transmitter 16 and an ultrasonic receiver 18 are formed.

The transmitter 16 is circular and located in the centre of the die. The receiver 18 is much smaller than the transmitter 16 and is located in the unused space in each corner of the die. Other numbers of receivers may be provided; they could be located elsewhere or more than one could be located in each corner. The transmitter could be differently shaped or located and/or multiple transmitters could be provided.

The individual dies 14 are tessellated together in a mutually abutting relationship on a common substrate (not shown) to form the array. The dies 14 are half a wavelength wide, such that the centre-centre spacings 20 of the transmitters 16 in both the X and Y directions are also half a wavelength. The receivers 18 in the respective corners of adjacent dies form respective 2×2 mini arrays 22. These mini arrays 22 are also separated by half a wavelength.

Although only six dies 14 are shown in FIG. 2, in exemplary embodiments, there may be many dies 14 in one or both dimensions of the array 4.

In operation, the ultrasonic array 4 emits a steered ultrasonic beam. Determined phase adjustments are applied to the signals from respective transmitters 16 or receivers 18 to allow them to act as a coherent array—e.g. for beamforming. Beam steering may be used on either the transmitted ultrasonic signal, reflected ultrasonic signal, or both. In order to steer the transmitted ultrasonic signal, the determined phase adjustments are added to the signal transmitted by each transmitter 16 in the array 4 such that the resultant transmitted ultrasonic signals undergo interference, resulting in an overall signal which is transmitted in a desired direction. The received, reflected ultrasonic signal may be steered in a similar way. Determined phase adjustments may be applied to the received signals from all directions to determine the reflected signal from a single direction in the surrounding structure.

Most standard beamforming algorithms benefit from half wavelength spacing of the ultrasonic elements 16, 18 as this enables each incoming wave front to be discernible from other incoming wave fronts with a different angle or wavenumber, in turn preventing the problem of ‘grating lobes’. Classical beamforming methods that benefit from half wavelength (or tighter) spacing includes (weighted) delay-and-sum beam formers, adaptive beam formers such as MVDR/Capon, direction-finding methods like MUSIC and ESPRIT and Blind Source Estimation approaches like DUET, as well as wireless communication methods, ultrasonic imaging methods with additional constraints such as entropy or information maximisation.

FIG. 3 is a schematic diagram of imaging an object 24 in a room 26 using direct reflections 30 from the object 24 and indirect reflections 34 which travel via the walls 28. An ultrasound imaging system 2 comprising an ultrasonic array 4 of transmitters and receivers as described above with reference to FIG. 2 is affixed to a wall 28 of the room 26.

The locations of the walls 28 may be determined using LI DAR scanning, or a CAD drawing of the room which is input to a CPU. Alternatively, the array 4 is used to determine the locations of the walls 28 when the room 26 is empty. The ultrasonic transmitters 16 in the array 4 emit ultrasonic signals which are reflected by the walls 28 of the room 26. These reflected signals are received by the receivers 18 in the array. The CPU then processes the data relating to the transmitted and reflected signals to determine the locations of the walls 28 which the signals were reflected from.

Once the location of the walls 28 have been determined, the imaging system 2 is used to image the object 24 in the room. A first beam 30 is directed into the near field and reflects off the object 24. The reflected beam 30 is a band limited Dirac pulse 32 which is received by the receivers 18 in the array 4, and provides limited information about the portion of the object which is in the line of sight of the transmitters and receivers in the array. Other signals, such as chirps/frequency sweeps, or other coded signals could be used, combined with suitable processing post-reception, such as pulse-compression techniques.

In order to gain further information about the dimensions and location of the object 24, a second beam 34 is then directed towards a wall 28a of the room 26. This beam 34 is reflected off the first wall 28a towards the back wall 28b. The beam 34 is then reflected towards the object 24, and the beam 34 is then further reflected off the object 24 back to the array 4. As with the first beam 30, the reflected second beam 34 is a band limited Dirac pulse 36 which is also received by the receivers 18 in the array 4.

As shown in the time-domain signal traces on the right of FIG. 3, the first reflected pulse 32 is received earlier than the second reflected pulse 36 as the first beam 30 travels a shorter distance than the second beam 34. In order to determine the location of the object 24 in the room 26, the received signals 32, 36 are processed by the CPU 8 which then uses this information, along with the known dimensions of the room 26 to determine the location of the object 24.

The calculations below provide further detail on the processing performed by the CPU 8 on the received signals 32, 36 in order to determine the location of the object 24.

Firstly, consider the hypothetical and simplified scenario where there is a single reflector 74, a transmitter 70 and a receiver 72, as shown in FIG. 4. Then, assuming a bandlimited Dirac pulse transmitted from the transmitter 72 ∂(t), the receive signal is

y(t)=α·l₁·∂(t−τ₁)

Where a represents the reflective strength of the target at the specified grid position, l₁ is the path loss (the longer the path the larger the loss), and ∂(t−τ₁) is the originally transmitted Dirac pulse, time-delayed by the delay factor τ₁. The path loss l₁ can be explicitly computed based on the wave propagation model, i.e. for a spherical wave in 3D it will typically be 1 divided by the travel distance squared.

The received samples y(t) can be put into a vector of length L (i.e. containing L samples) according to the equation:

$$y ( t ) = [ \begin{matrix}y ( t ) \\ y ( t + 1 ) \\ y ( t + 1 ) \\ ⋮ \\ y ( t + L - 1 )\end{matrix} ]$$

assuming the signals have been sampled at the receiver from points t to t+L−1.

Multiple reflective paths are shown in FIG. 5. The receive signal therefore becomes

y(t0=α·l₁·∂(t−τ₁)+α·l₂·∂(t−τ₂)

where there are now two different paths losses, l₁ and l₂.

More generally, there may be several different echoic paths, as illustrated by FIG. 6. The receive signal y(t) therefore becomes

$$y ( t ) = {\sum }_{r = 1}^{Q} α \cdot {l}_{r} \cdot \partial ( t - {τ}_{r} ) = α {\sum }_{r = 1}^{Q} {l}_{r} \cdot \partial ( t - {τ}_{r} )$$

which may also be represented as

$$y ( t ) = α {\sum }_{r ∈ S} {l}_{r} \cdot \partial ( t - {τ}_{r} )$$

S is a set of path index integers, typically i.e. S={1, 2, 3, 4, 5, . . . } representing the varying echoic path indexes, sorted in order of path length. S is the echoic index set.

Next, if there are several transmitters 70 and receivers 72, as shown in FIG. 7, subscripts are introduced on the receive signal y, to make sure the ij'th transmitter/receiver pair 70/72 are represented. The time delays τ, the path losses l and the echoic index sets will also be indexed accordingly, as they too depend on the relative physical positioning of the transmitters and receivers relative to the hypothetical reflective point. The equation therefore becomes

$${y}_{ij} ( t ) = α {\sum }_{r ∈ {S}_{ij}} {l}_{ijr} \cdot \partial ( t - {τ}_{ijr} )$$

The number of hypothetical reflective grid points α may then be increased, as shown in FIG. 8. FIG. 8 shows only 6 points for the sake of visibility, but in practise the whole grid may be included. For each transmitter/receiver pair 70, 72, this means that the echoes from each of these points are summed up to give the overall received signal, i.e

$${y}_{ij} ( t ) = {\sum }_{k = 1}^{P} {α}_{k} {\sum }_{r ∈ {S}_{ijk}} {l}_{ijrk} \cdot \partial ( t - {τ}_{ijrk} )$$

αₖ is the strength of the k'th hypothetical reflector for the 1^{st} to the P'th reflector under consideration. The path lengths lᵢⱼᵣₖ, the time delays ijrk and the echoic index now depend on the positions of the transmitters 70, receivers 72, reflectors 74 and the echoic path number. This may be rewritten in matrix/vector form by defining:

$${y}_{ij} ( t ) = [ \begin{matrix}{y}_{ij} ( t ) \\ {y}_{ij} ( t + 1 ) \\ {y}_{ij} ( t + 1 ) \\ ⋮ \\ {y}_{ij} ( t + L - 1 )\end{matrix} ]$$

And using the definition

$${d}_{ijk} ( t ) = {\sum }_{r ∈ {S}_{ijk}} {l}_{ijrk} \cdot \partial ( t - {τ}_{ijrk} )$$

The matrix Dᵢⱼ(t) is then defined as

$${D}_{ij} ( t ) = [ \begin{matrix}{d}_{ij 1} ( t ) & {d}_{ij 2} ( t ) & … & {d}_{ijP} ( t ) \\ {d}_{ij 1} ( t + 1 ) & {d}_{ij 2} ( t + 1 ) & … & {d}_{ijP} ( t + 1 ) \\ ⋮ & ⋮ & & ⋮ \\ {d}_{ij 1} ( t + L - 1 ) & … & … & {d}_{ij P} ( t + L - 1 )\end{matrix} ]$$

Where L is a suitable window length for the number of samples in the vector yᵢⱼ(t), and also the number of rows in Dᵢⱼ(t). This therefore gives the set of equations

yᵢⱼ(t)=Dᵢⱼ(t)α

Where i=1, . . . , N and j=1, . . . , Q, where N is the number of transmitters 70, and Q the number of receivers 72. Multiple transmit-receive pairs 70, 72 can be used to better estimate the vector containing reflective coefficients α, by stacking these equations and removing the time dependence temporarily for notational convenience:

$$[ \begin{matrix}{y}_{11} \\ ⋮ \\ {y}_{NQ}\end{matrix} ] = [ \begin{matrix}{D}_{11} \\ ⋮ \\ {y}_{NQ}\end{matrix} ] α$$

Or more generally, y=Dα, or if additive noise is to be incorporated, y=Dα+n, where n is a vector of additive noise. It should be clear from the above, that the more echoic paths there are, the higher each subblock Dᵢⱼ becomes, and therefore the equation system becomes better conditioned. In other terms, the echoic multipath situation helps improve the solvability of the equation and, in the presence of noise, improves the SNR. This equation set can be solved in any number of suitable ways, including least-squares, weighted least squares, various techniques incorporating knowledge of the noise characteristics, such as its spatio-temporal distributions etc.

FIG. 9 is a schematic diagram showing use of the ultrasound imaging system 2 for imaging a complex-shaped object 38 in the room 26 using beam steering to image the near field 42.

The array 4 emits a steered ultrasonic beam 40 which is focused in the near field 42. The beam 40 may also be ‘steered’ in post-processing of the reflected signal to obtain a steered received signal. The beam 40 is reflected from the front of the complex object 38 back towards the array 4 where the reflected beam is received. However, this only provides information about the side of the object which is close to, and facing the array 4.

Once sufficient data has been gathered using direct reflections from the object 38, in order to image the remainder of the object, the array 4 steers the ultrasonic beam towards the walls 28 of the room 26, away from the shortest path as shown in FIG. 10.

FIG. 10 is a schematic diagram of imaging the complex object 38 in the room 126 using indirect reflections from the walls 28. The beam 44 is directed towards a wall 28. The beam 44 is reflected from the wall 28 towards the object 38. This, in effect, means the wall 28 acts as an ultrasonic emitter, directing the beam 44 towards the object 38 to be imaged.

The beam 44 will reflect from the object 38 along a different path (not shown) towards the wall 28, and from there back to the ultrasonic array 4. The time delay in this beam being reflected back to the array 104, along with the predetermined locations of the walls is used by the CPU to gain further information about the size, shape and location of the object 38.

In open acoustic scenes, such as that of FIG. 11, which shows the same object 38 being imaged as in FIGS. 9 and 10 there is typically a lot of “empty space” in the scene, i.e. positions that cause no reflection, and for which a “reflective coefficient” αₖ in the vector α is naturally zero. This is in contrast with medical ultrasound imaging, where reflections will be obtained from multiple layers within the body. For a dense sampling grid, there are typically many more columns in the matrix D, defined previously, than there are rows, and so it is always possible to find some solution to a problem such as

min_{α}∥y−Dα∥₂²

This is one way of solving the above-mentioned problem of an open acoustic scene. However, given the dimensions of D—assuming it is made up from a tightly spaced grid of hypothetical reflectors—there will typically also be infinitely many such solutions α and so it makes sense to try to pin down the most “physically likely” of those. One approach for this is the compressive sensing approach, where one instead tries to solve

min_{α}|α|₁ subject to y=Dα (Eq. A)

i.e. to find the solution to the problem that has the smallest L1-norm. This is frequently a good approximation to the best L0-norm solution, which is the solution with the fewest number of non-zero coefficients. Having a high number of zeros reflects the previously known underlying hypothesis that the scene is largely full of “zeros” or non-reflective points, i.e. empty spaces.

More generally, the dimensions of the equation system can be such that the number of coefficients in α representing the entire acoustic scene can be in the hundreds-of-thousands of coefficients or more, so any dimension-reduction will drastically save compute time and complexity. To this end, if some of the coefficients in α can be known or computed before others, using simplified means to a general, big inversion, both time/CPU resource consumption and accuracy can be improved. The equation may be subdivided into

y=Dα=Dᵤαᵤ+Dₖαₖ

Where y−Dₗαₖ=Dᵤαᵤ_{ᵤ}αᵤ is the part governing the unknown coefficients of a (here, in αᵤ, the “u” subscript denotes “unknown”). Dₖαₖ governs the known coefficients of a (the “k” subscript denoting “known”). Then a new equation system can be obtained:

y−Dₖαₖ=Dᵤαᵤ

Which can be solved for a u which will have fewer dimensions than the original problem where a was to be estimated. Approaches to (easily) obtaining some coefficients involve the following: first, in FIG. 11, a pulse is transmitted from the transmitter 16 and received by the receiver 18 in the array 4. If during the first sampling period of K samples (illustrated by the cut-off circle 42) are all zero or close to zero, then clearly all the coefficients representing possible reflectors within this boundary must be zero, as illustrated. This provides an initial set of αₖ samples which can be used to reduce the dimensions. The exact number of zeros in this example is 22.

Next, referring to FIG. 12, the receive sampling window 42 is stretched a little further, and the first few incoming echoes occur within this window, i.e non-zero samples. Since the location of the reflector 38 is not yet known there is at this point an ‘arc’ of potential locations for the reflector, indicated by “x”s. Note, there are still only a modest number of unknowns in this equation system (29 ‘x’ es), at least compared with all the samples being included, i.e. relaxing the limit on the sampling period. Note that this “cut-off” can happen in the time-domain by ignoring later arriving samples, or in the “impulse response domain”. The “impulse response domain” is the situation where the impulse response is estimated using a suitable coded output signal followed by pulse (de-) compression at the receive side, or in any other suitable domain.

Now, utilizing the previously known αₖ samples, a new equation system can be created with 29 unknowns, and those can be estimated. Then, there are 29+22=51 known/estimated samples that can be utilized as more samples are obtained in the “cut-off approach”. Overall, a sequence of estimators are being driven, each with lower dimensions than the full imaging problem, to gradually create a full image of the scene. Any estimation step can utilize any of the aforementioned techniques, including compressed sensing to obtain physically plausible estimates of the acoustic scene.

Of course, it is not essential to use Eq. A above. Any other suitable method utilizing the sparsity of the scene could be employed, using other norms than L1/L0, and other norms or measures of sparsity, such as information-theoretic approaches optimizing properties like the distribution of coefficients, e.g. the super-Gaussian distribution properties. Bayesian approaches such as Bayesian Sparse Regression, could be also employed, see e.g. https://arxiv.org/abs/1403.0735.

The direct path reflections shown in FIGS. 9, 11 and 12 result in the portion of the room 26 which is ‘behind’ the object 38 relative to the array 4 being occluded. FIG. 13 is a schematic diagram of imaging an occluded object 46 in the room 26. As is clear from FIG. 13, due to the object 38 between the array 4 and the occluded object 46, the beam 48 which would be direct from the array 4 to the occluded object 46 cannot be used to image the occluded object 46, as it would instead be reflected from the first object 38.

Therefore, in order to image the occluded object, an ultrasonic beam 50 is directed towards a wall 28, the location of which is known. The beam 50 is reflected off the wall 28 directly towards the occluded object 46, without being reflected off the first object 38. The beam 50 will therefore be reflected from the occluded object 46 back to the wall 28 along a different path (not shown), and to the array 4, where the received echoes are analysed by the CPU 8 to image the objects 38, 46. The indirect ultrasonic reflections therefore allow for imaging of objects in the room which are occluded from line of sight imaging from the array by other objects in the room.

The calculations below provide further modifications on the processing described above which is performed by the CPU 8 on the received signals 40, 44, 50 in order to determine the location of the objects 38, 46. These modified calculations remove the occluded paths 50 from the data set in order to reduce the computational load on the CPU 8.

The general model, y=Dα does not incorporate effects such as occlusions, it simply assumes that sound propagates “unhindered” through all the reflective voxels. Referring back to the equation

$${y}_{ij} ( t ) = α {\sum }_{r ∈ {S}_{ij}} {l}_{ijr} \cdot \partial ( t - {τ}_{ijr} )$$

this problem can be managed by using knowledge of the first pixels/reflectors to effectively rule out potential echoic paths in the set Sᵢⱼ. Referring now to FIG. 14, the potentially reflective point 46 has an acoustic two-way path 48 which is effectively blocked by the front-lying reflectors in the cluster 38. Hence, this echoic path is now removed in every relevant set Sᵢⱼ for each relevant transmitter/receiver pair in the array 4 (i.e. for those pairs for which the path is blocked). This approach mitigates the problem with occlusions and the potential errors associated with any of the coefficients in a that would follow from not dealing with it, and it also reduces the overall computational load by reducing the number of echoic paths represented as columns in D.

Finally, knowledge of previously (sequentially) estimated reflectors can be used to steer the acoustic beam in certain directions and away from others. In FIG. 15, the transmit and/or receive array 4 is configured to focus sound in the beam pattern 42 and in the direction 49. This sets the system up for imaging the hidden object 46. However, as sound returns from this emission, before receiving an echo from the object 46, it will be observed that many of those samples are 0 or close to 0, meaning that the coefficients in the sector can be set to 0. This is illustrated with the 0 elements in FIG. 15. Again, the knowledge of the acoustic scene using beam-steering techniques is increased, reducing computational complexity and reducing errors.

FIG. 16 is a flowchart illustrating a method of imaging an object 38, 46 in the room 26, as shown in FIGS. 9-13. At step 52, the near field to the array 4 is imaged using beam forming. A beam 40 is directed towards the object 38 to be imaged, e.g. as shown in FIG. 9. In order to improve the nearfield imaging, at step 54, a beam 44 is steered away from the shortest path and towards a wall 28. The beam 44 is then reflected from the wall 28, such that the wall acts as a ‘transmitter’ emitting the beam 44 towards the object 38 to be imaged.

The reflected beams 40, 44 which may be described as band limited Dirac pulses are input into the equations described above, and the inverse equation y=α^{T}D used to determine α which describes the reflectivity at all grid points, and therefore can be used to provide an image of the object 38.

At step 56, this inverse equation is modified to remove blocked paths, such as path 48 shown in FIG. 13. This reduces the computational load as the number of calculations which must be carried out by the CPU 8 are reduced. At step 58, the modified inverse equation is solved, therefore obtaining images of any objects 38 in the room 26, as well as any occluded objects 46.

FIG. 17 is a flowchart illustrating a modified method of imaging an object 38, 46 in the room 26, as shown in FIGS. 9-13. Steps 60 and 62 describe the same method as steps 52 and 54 in FIG. 9, where the near field to the array 4 is imaged using beam forming, and then in order to improve the nearfield imaging, a beam 44 is steered away from the shortest path and towards a wall 28. The beam 44 is then reflected from the wall 28, such that the wall acts as a ‘transmitter’ emitting the beam 44 towards the object 38 to be imaged.

At step 64, the equation y=Dα is solved for the nearfield reflected beams 40, 44. This gives information relating to the location of the object 38, and the beam steering is therefore modified in order to further image the object 38. Through an iterative procedure of steering a beam, receiving the reflected signal, determining information about the object 38, and modifying the direction of the beam, extensive information about the object 38 location and shape may be obtained.

As with the method described in FIG. 16, the inverse equation is then modified to remove blocked paths, such as path 48 shown in FIG. 13. This reduces the computational load as the number of calculations which must be carried out by the CPU 8 are reduced. At step 68, the modified inverse equation is solved, therefore obtaining detailed images of any objects 38 in the room 26 through the iterative method of steps 62 and 64, as well as any occluded objects 46.

Referring back to FIG. 10, it is clear that the length of the path 44 could be incorrectly computed, perhaps as a result of a mis-estimation of the exact position or angle of the wall 28. Going forwards with computing the reflective coefficients in the area 38 may then give a ‘wrong’ result. In practice, the typical result will be that of “smearing out” the image, because a new reflective coefficient will likely have to be given a positive value to account for the observed reflection via the path 44. This means that the “sharpness” of the overall image can be used as a criterion with which to optimize the positions of the enclosure, or alternatively, try to re-compute the correct acoustic path length, which could be affected by things like turbulence. Measures such as image sharpness, see https://ieeexplore.ieee.org/document/6783859, or the ratio between low reflector values (close to 0) and high reflective values can be used to compute such sharpness. This enclosure-updating approach can be particularly useful when the enclosure is known to change, such as for a robot gripper-arm as will be described below with reference to FIG. 23.

Referring to FIG. 18 now, at step 61 an initial image is computed using an initial set of parameters derived from a the current assumption of the location of the surrounding structure; wall, ceilings, floors, objects etc, using the calculated times-of-flight for both direct reflections and indirect reflections. At step 63 the image sharpness is computed, and at step 65 a new set of enclosure parameters is generated. This could be done randomly, as a perturbation to the current parameter set, or, as the algorithm proceeds in iterations, it could be based on previous guesses of the parameters and associated image sharpness scores. In step 67 the new image is computed and its sharpness assessed. In step 69, the sharpness score is matched against a criterion. This could be an absolute criterion, e.g. a fixed threshold as to what is determined to be ‘good enough’ (or not), or it could be a dynamic one which is computed or set based on how well other previous estimates scored, i.e. a local optimum criteria. In step 71 once the threshold has been met, the program exits and returns both the optimized image and the updated enclosure parameters.

FIG. 19 shows an array of ultrasonic transducers 75 and microphones 76 used to obtain sound from a specific person 78 in the room 80. Given the position of the target person 78 in the room, p=[x, y, z], and the position of all the microphones used for trying to capture audible sound are x₁, x₂, x₃, . . . x_{N} the expected time of flight between the target 78 at position p and each of the microphones in the array 76 can be computed, via the formula s=v*t (distance equals speed times time), as

$${Δ}_{i} = \frac{1}{c} ‖ {x}_{i} - p ‖$$

where c (or v) is the speed of sound.

The microphones 76 can be placed anywhere in the room. The location of microphones 76 can be computed using any suitable means. The ultrasonic array 75 may be used to determine the position of the speaker 78, and/or microphones 76 using ultrasound.

Assuming the target person 78 is the only active audio source in the room, the received signals y₁(t), y₂(t), y₃(t), . . . y_{N}(t) can be expressed as

yᵢ(t)=s(t−Δᵢ)+n(t)

Where s(t) is the “spoken word”, i.e. the sound produced by the target person, and n(t) is the sensor noise. An alternative way of expressing this is

yᵢ(t)=s(t)*∂(t−Δᵢ)+n(t)

Where ∂(t) is the delta Dirac functions. Both equations essentially say that each microphone receives an appropriately time-delayed version of the sounds output from the target person. For simplicity of explanation, no attenuation term has been included, but they can be readily incorporated as will be appreciated by those skilled in the art.

A straightforward way to recover signal-of-interest s(t) is by delaying-and-summing, i.e

$$\begin{matrix}{\hat{s}}_{i} ( t ) = {\sum }_{i = 1}^{N} {y}_{i} ( t ) * \partial ( t + {Δ}_{i} ) \\ = {\sum }_{i = 1}^{N} [ s ( t ) * \partial ( t - {Δ}_{i} ) + n ( t ) ] * \partial ( t + {Δ}_{i} ) \\ = {\sum }_{i = 1}^{N} s ( t ) * \partial ( t - {Δ}_{i} ) * \partial ( t + {Δ}_{i} ) + n ( t ) * \partial ( t + {Δ}_{i} ) \\ = {\sum }_{i = 1}^{N} s ( t ) + n ( t ) * \partial ( t + {Δ}_{i} ) \\ = N \cdot s ( t ) {\sum }_{i = 1}^{N} n ( t ) * \partial ( t + {Δ}_{i} )\end{matrix}$$

Where the first part becomes an amplification of the source s(t) (added up N times), and the second part becomes a sum of incoherent noise components, i.e. the parts of the noise component that do not sum up constructively. The overall result is an amplification of the signal-to-noise ratio via delay-and-sum beamforming. In the frequency domain, this could be expressed as:

Yᵢ(ω)=S(ω)*Dᵢ(ω)+N(ω)

Where Dᵢ(ω) is the phase delay associated with the time delay Δᵢ for the specific frequency ω. Note that Dᵢ(ω) has unit modulo (i.e. it only phase delays the signal, it does not amplify or attenuate it in accordance with the assumption explained above). In the frequency domain, the delay-and-sum recovery strategy thus becomes:

$$\hat{S} ( ω ) = {\sum }_{i = 1}^{N} {Y}_{i} ( ω ) {{D}_{i} ( ω )}^{*}$$

Where the effect of Dᵢ(ω)* to cancel out the effect of Dᵢ(ω), to once again get an amplification of the signal relative to the noise. This gives rise to the term phased array, i.e. the phase information in some or all frequency bands is used constructively to recover the signal of interest. Note also, that, in the case of an interfering signal being added to the mix, i.e.

Yᵢ(ω)=S(ω)*Dᵢ(ω)+Z(ω)*Fᵢ(ω)+N(ω)

If Z(ω) is the interfering signal originating at some other location q and being delayed towards each of the microphones 76 via the individual time delay represented as Fᵢ(ω) then the same delay-and-sum strategy would also serve to reduce the effect of the interfering signal in the output result relative to the signal of interest, i.e. the strategy would use the phase knowledge to improve the signal-to-noise-and-interference ratio.

Other more sophisticated techniques existing for signal source enhancement. Some take into account the positions and/or statistical acoustic properties of an interfering source i.e. not simply smear the out to reduce their impact, as in the above example. Minimum Variance Distortionless receiver (MVDR) or Capon beamforming, is but one example.

Moreover, if the acoustic transfer functions, or impulse responses from each source 78 to each microphone 76 are known, better results may be obtained, because impulse responses can take into account not merely the direct path of the sound from the person 78 towards each of the microphones 76, but also any subsequent echo coming from a sound impinging on a wall 82, ceiling or other object. Letting Hᵢⱼ(ω) denote, in the frequency domain, the impulse frequency response from source j, j=1, . . . Q, to microphone number i, then we have, assuming Sⱼ(ω) to be the source signal from the j'th source:

$${Y}_{i} ( ω ) = [ {\sum }_{i = 1}^{Q} {H}_{ij} ( ω ) {S}_{j} ( ω ) ] + {N}_{i} ω )$$

This can be put into vector-matrix notation by stacking the successive microphone inputs in a vector as:

Y(ω)=H(ωS(ω)+N(ω)

Here H(ω)={Hᵢⱼ(ω)}, S(ω)=[S₁(ω), . . . S_{Q}(ω)]^{T}, Y(ω)=[Y(ω), . . . Y_{N}(ω)]^{T} and N(ω)=[N₁(ω), . . . N_{N}(ω)]^{T}. A similar formulation exists in time-domain where the effect of the impulse responses in the time-domain, i.e. hᵢⱼ(t) (which are convolved with the source signals sᵢⱼ(t)) build up a block Toeplitz matrix system.

One can now compute an estimate of the sources as:

Ŝ(ω=H⁺(ωY(ω)

Where H⁺(ω) is a suitable inverse matrix of H(ω). This could be a Moore-Penrose inverse, a regularised inverse to match the noise level, such as Tikhonov regularization, or a generalized inverse utilizing knowledge of the noise characteristics, such as a Bayesian estimator. Whether used in the time or frequency domain, any of the following techniques can equally well be used:

Minimum Mean Square Error (MMSE) receiver strategies, Blind Source Separation or Independent Component Analysis, Blind Source Separation approaches utilizing statistical properties related to the signal-of-interest, Sparse methods such as Bayesian models with Gaussian Mixture Models or L1-based regularization methods such as in compressed sensing, or any other suitable technique that utilizes phase information.

In practice, this means that in accordance with embodiments of the invention audio capture can be improved in two important ways: first, the location of the person 78 in the room 80, i.e. the position p, can be estimated. Moreover, a statistical “map” of his or her range of movements and likely positions can be computed—even if he or she is not speaking—so that the audio signal processing can be optimized for this purpose. Secondly, the location of the walls 82 and ceilings can be used to compute the impulse response functions H(w) above, which is what enables the sound to be focused using the ceilings and walls 82 and/or other reflective items. So the information captured in the ultrasound domain can usefully be employed in the audio domain.

Turning now to transmission, such as in a directed hi-fi sound reproduction system as shown in FIG. 20, it is similarly assumed that the locations of the loudspeakers 84 are known (as for the microphones above) and that the location of the target 78 is also known. Then, the time-delays used above can be used to define each output signal sⱼ(t) to be output from loudspeaker j as:

sⱼ(t)=s(t)*∂(t+Δⱼ)

In which case, the signal received at the position of the target person 78 would be:

$$\begin{matrix}y ( t ) = {\sum }_{i = 1}^{N} {s}_{j} ( t ) * \partial ( t - {Δ}_{j} ) \\ = {\sum }_{i = 1}^{N} s ( t ) * \partial ( t + {Δ}_{j} ) \partial ( t - {Δ}_{j} ) \\ = {\sum }_{i = 1}^{N} s ( t ) * \partial ( t ) \\ = {\sum }_{i = 1}^{N} s ( t ) = Ns ( t )\end{matrix}$$

i.e. an amplification of the signal at the focus point p where the person 78 is. If the person 78 moved to another location p′, then there would not be the same amplification, because the terms ∂(t+Δⱼ)∂(t−Δⱼ) would be replaced by ∂(t+Δⱼ)∂(t−τⱼ) for some τⱼ which would generally not combine to become ∂(t).

Instead, the effect would be a “smearing out” of the outputs and effective lowering of the N-time amplification observed at p. A parallel argument can be made in the frequency domain, making it apparent that the system is relying on phase delays of the transmit signals to obtain the local focussing effect.

Also on the transmit side, it is possible to utilize detailed knowledge of the impulse response function to create even better focussing utilizing reflectors like walls 82 and ceiling or other large objects. For instance, if hᵢⱼ(t) is the impulse response between each transmitter j and each target i, then the sound received at each target i can be jointly modelled as:

$$[ \begin{matrix}{y}_{1} ( t ) \\ ⋮ \\ {y}_{Q} ( t )\end{matrix} ] = [ \begin{matrix}{H}_{11} & … & {H}_{1 N} \\ ⋮ & ⋱ & ⋮ \\ {H}_{Q 1} & … & {H}_{QN}\end{matrix} ] [ \begin{matrix}{s}_{1} ( t ) \\ ⋮ \\ {s}_{N} ( t )\end{matrix} ]$$

Or

y=Hs

The matrices Hᵢⱼ are the aforementioned Toeptliz matrices containing the impulse responses hᵢⱼ(t) as its shifted rows, sⱼ(t) is the sampled vector to samples output from speaker j, and yᵢ(t) the sound that is received at the i'th target location, for i=1, . . . Q.

The speakers 84 can be placed anywhere in the room. The location of speakers 84 can be computed using any suitable means. The ultrasonic array 75 may be used to determine the position of the user 78, and/or speakers 84 using ultrasound as previously described herein.

It is now possible to select transmit signals {sⱼ(t)} so that the received signals become “the desired ones”, i.e. that a specific sound is observed at some location I and an entirely different sound at location j—even though the original transmit signals {sⱼ(t)} all contain mixes of those specific sounds. One straightforward example is to let s=H⁺y, where H⁺ denotes the Moore-Penrose Inverse of H. More sophisticated techniques capable of dealing with noise robustness can be envisaged too, as explained above for the receive/sound capture scenario. Note that in the above, the entire impulse response, i.e. not just the direct time-of-flight path, can be utilized for audio focussing.

In some situations the exact position of the person 78 onto which the sound is to be focused may not be known, i.e. there is uncertainty connected with the position p for that person 78, or there may be multiple persons 78 present. In the receive scenario of FIG. 19, different beam-forming or inverse matrix computations may be utilised to get the optimum sound capture, but for the transmit case shown in FIG. 20, once the sound is transmitted, that opportunity is gone. So, referring to the equation y=Hs above this may be dealt with by providing multiple target points placed close to one another, or in two or more groups of “cluster points”. The number of target points, and therefore the number of row blocks in the matrix H above can be in the hundreds or thousands, with the net effect of making a broader focussing zone. The complexity of the inverse problem does typically not change dramatically, as the matrix H is typically pre-multiplied by its transpose H^{T} before inversion of the product H^{T}H.

Again, as with the audio receiving situation of FIG. 19, this means that the invention as claimed can be used to map both the room 80 and the movements of the person or persons 78, and by combining the two, obtained a vastly improved overall audio experience. As with the receiver case of FIG. 19, the invention can be used to create a statistical map of the persons 78 whereabouts, and use this information for optimization of audio “steering” in FIG. 20.

The imaging approach where ultrasound is used to map an environment by utilizing reflections from the enclosure 86 is shown in FIG. 21. The same concepts as were used to steer the audio propagation for sound transmission and reception in FIGS. 19 and 20, can now be used to steer the ultrasound used for imaging in certain directions or towards certain positions, and away from others. In this example, a container 86 includes an ultrasonic array 88, which is used to image the dimensions of the container 86, as well as how full the container 86 is, in this scenario, with refuse 90.

Referring back to the equation y=Hs, the (stacked) transmit signals held in s, may be chosen in such a way that a desired signal set in the (stacked) vector y is at least approximately obtained. The problem of choosing the sources s may be reformulated as:

$${min}_{s} {‖ y - Hs ‖}_{F}^{2} = {\sum }_{k = 1}^{Q} {‖ {y}_{k} - {H}_{k} s ‖}_{2}^{2} = {\sum }_{k = 1}^{Q} {( {y}_{k} - {H}_{k} s )}^{T} ( {y}_{k} - {H}_{k} s )$$

Where H k denotes the k'th block row of the matrix H, i.e. Hₖ=[Hₖ₁, . . . , H_{kN}]. Weightings can be introduced to the right hand term, i.e. to create a weighted cost function

$$f ( s ) = {\sum }_{k = 1}^{Q} {( {y}_{k} - {H}_{k} s )}^{T} {W}_{k} ( {y}_{k} - {H}_{k} s )$$

Where the matrices {Wₖ} are typically diagonal matrices with positive indices. By choosing these weight matrices carefully, certain points in time and space can be “set” where there isn't any energy. For instance, for a specific hypothetical point k with an associated target signal yₖ, yₖ=0, and the associated Wₖ=αI, where α is a large positive integer.

At the same time, another vector yᵢ, can be chosen, for l≠k, which is a zero-padded spike or sinc signal, and a suitable weight matrix Wₗ=αI. It may also be desirable to take less account of energy that arrives at a certain point after a given time, but to take greater account of the fact that there is no energy at this point or other points early on. This is equivalent to “steering energy” away from an object, see FIG. 21. This can be accomplished by choosing the target vector yₖ=0 as explained, but letting Wₖ=αD, where the matrix D is a diagonal matrix with diagonal elements equal 1 for the first K samples (say, the first 500 samples) and 0's after that. In effect, this means that no energy is desired for the first 500 samples picked up at that location, but after that it doesn't matter. This can be seen as a reasonable compromise because given all the reflections in the scene it is very hard to create a “permanent hull” or zero at a given point. However, it is possible to steer the ultrasound with a directivity pattern so that initially at least, there is no “directional energy” in a certain sector. As shown in FIG. 21, the signals 92 are steered toward the walls of the container 86, or towards the refuse 90, rather than being directed towards empty space in the container which will not provide any useful imaging information.

FIG. 22 shows another exemplary embodiment of the invention in the form of a café where an array of ultrasonic transducers 94 are used to determine the location of people 96 in the room 98. Reflections of the transmitted ultrasonic signal from the wall 100 enable an obscured person 96a to be imaged, even though they are not in the direct line of sight of the array 94. It may be useful to monitor what goes on in the room 98, as new customers 96 move in and out and around. For example, the distances between customers may be monitored to ensure they remain a certain distance apart e.g. 2 m under Covid-19 guidelines. The ultrasonic transducer 94 may therefore be used to monitor that guidelines are being adhered to by customers. In FIG. 22, the staff member 96b behind the counter 102 is imaged directly by the ultrasonic transducer 94. However, in some examples, once the dimensions of the room 98, and locations of fixed objects in the room 98, such as the counter 102 have been determined, the area ‘behind’ the counter 102 may not need to be imaged, as it is known that any person behind the counter 102 will be staff 96b, whose movements and location does not need to be monitored.

FIG. 23 shows another embodiment of the invention in the form of a robot gripper arm 104 with an ultrasonic transducer array 106. The robotic gripper 104 is being controlled to pick up a pencil 108. The shape of the robotic gripper 104 changes shape as it closes around the pencil 108. The ultrasonic array 106 is used to both determine the location of the surrounding structure—in this case the robot gripper 104 itself—as well as the location of the pencil 108. The ultrasonic array 106 therefore regularly updates the information relating to the positions of the robot gripper 104 hand and fingers, to improve the imaging of the pencil 108 as the robot gripper 104 changes shape as described above with reference to FIG. 18. Nearfield reflections 110 are used to image the pencil 108 being picked up by the gripper 104 as the gripper 104 moves towards the pencil 108 whilst changing its shape.

FIG. 24 shows an embodiment of the invention where an array of ultrasonic transmitters 122 are retrofitted to a device having a built-in array of MEMs microphones 124. In this example, the device is a voice-controlled smart speaker 120. The smart speaker 120 includes the microphones 124 spaced around the top part of the device, the array of ultrasonic transmitters 122 located in the centre of the top of the device, and a CPU 126 for processing received signals from the microphones 124 and controlling the transmitter array 122. The voice-controlled smart speaker 120 may be used as described in the foregoing description—to acoustically image objects within a surrounding structure. The microphones 124 each have a peak response in the frequency range of typical speech—e.g. between 50 Hz and 500 Hz. As the microphones 124 also have the capability to capture ultrasonic signals, a dedicated ultrasonic receiver array does not also need to be retrofitted. This helps the retrofitted component to be small and suitable for a wider range of devices. The transmitter array 122 is especially compact as it has a spacing equivalent to a half-wavelength of a sound wave in the ultrasonic frequency range, which helps to optimise the transmitter array 122 for ultrasonic beamforming.

The Applicant has also appreciated that the received signals in accordance with any of the foregoing aspects or embodiments of the invention can be processed to take into account Doppler information. This may enhance imaging performance even further.

There are several ways in which Doppler information can be used to enhance imaging performance. The following mathematics illustrates one way in which Doppler can explicitly be accounted for during processing.

Returning to the equation:

y(t)=α·l₁·∂(t−τ₁)

Where it is assumed that a Dirac pulse had been transmitted and has been received at a receiver as a time-series y(t).

More typically and as mentioned earlier in this application, coded signals may be used. Let x(t) be the bandlimited, linear output signal, which may for instance be a chirp signal.

Then y(t) can be obtained through the following:

y₀(t)=h(t)*x(t)+n(t),

y(t)=x(−t)*y₀(t)=x(−t)*h(t)*x(t)+x(−t)*n(t)

If x(−t)*n(t)=n₂(t):

y(t)=h(t)*x(−t)*x(t)+n₂(t)

If x(−t)*x(t)=∂_{B}(t), where ∂_{B}(t) is the bandlimited version of the Dirac impulse response, within the frequency band B defined by the signal x(t):

y(t)=h(t)*∂_{B}(t)+n₂(t)

Now, if a signal x(t) is transmitted and it bounces off a moving object, a major effect will be that of effectively stretching or compressing the transmit signal x(t) upon reception. This can be thought of in a slightly different way: the object staying still, but the transmit signal x(t) being stretched, or scaled in time so that it is now x(kt), where k is a constant positive number, typically close to 1.

This gives:

y₀(t)=h(t)*x(kt)+n(t),

y(t)=x(−t)*y₀(t)=x(−t)*h(t)*x(kt)+x(−t)*n(t)=h(t)*x(−t)*x(kt)+n₂(t)

However, the property x(−t)*x(t)=∂_{B}(t) is now missing. This mismatch can be taken advantage of, to construct a set of “x(−t) replacements”, which will focus the signal processing and subsequent image generation process onto objects with a specific Doppler shift only.

Now, to filter out and separate objects with a certain Doppler shift, a family of functions {\tilde{x}ₗ(t)} can be designed, which approximately satisfy the criterion:

$${\tilde{x}}_{l} ( - t ) * x ( k \cdot t ) = \{ \begin{matrix}{\partial }_{B} ( t ) for k = l \\ 0 for k <> l\end{matrix} \qquad Equation {(}^{*} )$$

Then, a single ‘slice’ of the imaging problem can be created by pre-convolving the received signal by any of the signals in the family. For instance:

\tilde{y}ₗ(t)=\tilde{x}ₗ(−t)*y₀(t)=\tilde{x}ₗ(−t)*h(t)*x(k·t)+\tilde{x}ₗ(−t)*n(t)

If \tilde{x}ₗ(−t)*n(t)=n₃(t):

\tilde{y}ₗ(t)=h(t)*\tilde{x}ₗ(−t)*x(k·t)+n₃(t)

and \tilde{x}ₗ(−t)*x(k·t)=∂_{B}(t) for k=l, 0 otherwise.

By picking the ‘right’ Doppler speed-related function \tilde{x}ₖ(−t), the objects in the scene with a specific Doppler shift can effectively be captured, while filtering others out. Imaging can then be continued, assuming that the output driving signal was in fact the bandlimited Dirac signal ∂_{B}(t).

The family of functions held in Equation (*) can be derived in any number of ways. One specific way to do it is to (a) resample the function xᵢ(k·t) with different values of k, to generate a family of vectors xₖ, momentarily skipping the index i, which is a common variable value when there is only a single transmitter. Then each of those vectors are used to generate an associated Toeplitz matrix Xₖ with the vectors xₖ as its (flipped) elements.

Then vector-approximations of the filters \tilde{x}ₖ(−t) can be computed as vectors hₖ. This is achieved by setting up the requirements:

$${X}_{r} {h}_{k} = \{ \begin{matrix}0 for r \neq k \\ d for r = k\end{matrix}$$

Where d is a vector of zeros with the exception of the centre element which is 1, or alternatively, d represents a sampled, bandlimited version of the Dirac function limited to the frequency band of interest. More specifically, the following function can be minimised:

$$min \{ {h}_{k} \} {\sum }_{r = 1}^{K} {\sum }_{k = 1}^{K} {‖ {X}_{r} {h}_{k} - {w}_{rk} ‖}_{2}^{2} \qquad Equation ( + )$$

Where wᵣₖ is 0 if r<>k and a vector sampled Dirac function if r=k and k is the number of relevant Doppler speed indexes. There are also other separation strategies than filtering, for instance deconvolution approaches could be used, the optimization problem above could be solved using other norms, or deep learning approaches could be used to design optimal filters.

More sophisticated filtering or deconvolution strategies could also be employed by assuming that only a few Doppler shifts are present at the same time, for example that most objects are static and only a few are moving at relatively high and known speed. This eases the pressure on the criterion (+) because the filter hₖ doesn't have to be orthogonal to all the other filters in the family, only to those objects whos speed match specific subsets of the filter family.

The following equation could then be solved:

$$min \{ {h}_{k} \} {\sum }_{r ∈ S} {\sum }_{r ∈ S} {‖ {X}_{r} {h}_{k} - {w}_{rk} ‖}_{2}^{2}$$

Where S is a subset of relevant speed indices, with |S|<K. The criterion will then be better fulfilled, getting closer to the design goal set up in (*).

Multiple other strategies for steering both transmit and receive beams exist in the literature, see e.g. Demi, L., “Practical guide to ultrasound beam forming: beam pattern and image reconstruction analysis”, Applied Sciences, 2018, 8, 1544.

It will be appreciated by those skilled in the art that the invention has been illustrated by describing one or more specific embodiments thereof, but is not limited to these embodiments; many variations and modifications are possible, within the scope of the accompanying claims. For example, the CPU may not be local to the imaging system and may instead be an external hub used for work-sharing, with data sent between the imaging system and hub via Bluetooth signals.

1. A method of imaging at least one passive object within a surrounding structure having a plurality of surfaces, the method comprising:
transmitting an ultrasonic signal into the surrounding structure using an array of ultrasonic transmitters;
receiving reflections from the passive object using an array of ultrasonic receivers;
steering the ultrasonic signal such that it includes at least one reflection off a surrounding structure surface using stored data relating to a position of at least one of said surfaces.

2-3. (canceled)

4. The method of claim 1, comprising using the ultrasonic transmitter array and/or the ultrasonic receiver array to estimate position(s) of the surrounding structure surface(s) prior to the steering.

5. The method of claim 1, comprising updating the surrounding structure surface information during imaging or between episodes of imaging.

6. (canceled)

7. The method of claim 1, comprising simulating, for one or more reflections of the ultrasonic signal from the array, an estimated received signal for the passive object and comparing the reflections which comprise an actual received signal against the estimated received signal.

8. The method of claim 7, comprising basing the estimated received signal on a simulated image from past characteristics of the surrounding structure, a past image of the passive object in the surrounding structure, or a preliminary image of the passive object.

9. The method of claim 7, comprising determining the accuracy of the estimated signal by comparing the estimated received signal with the actual received signal.

10. The method of claim 7, comprising performing a gradient search to compare the estimated received signal with the actual received signal.

11. The method of claim 1, comprising steering the transmitted signal based on characteristics of the passive object.

12. (canceled)

13. The method of claim 1, comprising imaging using a single steered ultrasonic signal.

14. The method of claim 1, comprising using the array to transmit multiple ultrasonic signals in different directions.

15. The method of claim 14, comprising transmitting the multiple ultrasonic signals simultaneously.

16. The method of claim 1, comprising modifying the shape of the transmitted ultrasonic signal to match that of the passive object by focussing the energy of the beam predominantly onto the passive object.

17-18. (canceled)

19. The method of claim 1, comprising creating a visual representation of the passive object.

20. (canceled)

21. The method of claim 1, comprising using compressed sensing and/or sparsity methods.

22. The method of claim 1, comprising calculating a Doppler shift of the ultrasonic signal and using said Doppler shift for said imaging.

23. A system arranged to image at least one passive object within a surrounding structure having a plurality of surfaces, the system comprising:
an array of ultrasonic transmitters arranged to transmit an ultrasonic signal into the surrounding structure; and
an array of ultrasonic receivers arranged to receive reflections from the passive object;
wherein the system is arranged to steer the ultrasonic signal using stored data relating to a position of at least one of said surfaces such that the ultrasonic signal includes at least one reflection off a surrounding structure surface.

24. The system of claim 23, having a single array comprising separate transmitters and receivers therein.

25-26. (canceled)

27. The system of claim 23, wherein the receiver array comprises Micro-Electro-Mechanical System microphones.

28. (canceled)

29. The system of claim 23, wherein the receiver array is a microphone array having a peak response in the audible frequency range; and the transmitter array has a spacing between the transmitters equivalent to a half-wavelength of a sound wave in the ultrasonic frequency range.

30. A device for imaging at least one passive object, the device comprising:
an array of ultrasonic transmitters, arranged to transmit an ultrasonic signal, wherein a pair of adjacent transmitters of said array has a spacing equivalent to a half-wavelength of a sound wave in the ultrasonic frequency range;
an array of microphones arranged to receive reflections from the passive object, wherein the microphones have a peak response in the audible frequency range;
wherein the device is arranged to determine an image of said object using said reflections.
